(19) United States
(12) Patent Application Publication
(10) Pub. No.: US 2026/0304357 A1
(43) Pub. Date: Oct. 1, 2026

(54) MEASUREMENT PERIOD CALCULATION FOR CARRIER PHASE POSITIONING MEASUREMENTS

(71) Applicant: QUALCOMM Incorporated, San Diego, CA (US)

(72) Inventors: Alexandros MANOLAKOS, Athens (GR); Carlos CABRERA MERCADER, Cardiff, CA (US); Sony AKKARAKARAN, Poway, CA (US)

(21) Appl. No.: 19/477,695

(22) PCT Filed: May 3, 2024
(86) PCT No.: PCT/US2024/027675

§ 371 Date: Oct. 22, 2025

(30) Foreign Application Priority Data
May 15, 2023 (GR) 20230100394

(51) Int. Cl. H04W 64/00; H04W 56/00; H04W 76/28

(52) U.S. Cl. CPC H04W 64/00; H04W 56/0015; H04W 76/28

(57) ABSTRACT

A user equipment (UE) may receive a configuration message including a timing window (TW) configuration for a set of positioning measurements on a set of positioning signals. The UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The UE may calculate a measurement period for the set of positioning measurements based on the previous calculation. The UE may receive the set of positioning signals. The UE may perform the set of positioning measurements on the set of positioning signals during a TW that is less than or equal to the measurement period.

### CROSS-REFERENCE TO RELATED APPLICATION

This application claims the benefit of Greece application No. 20230100394, entitled “MEASUREMENT PERIOD CALCULATION FOR CARRIER PHASE POSITIONING MEASUREMENTS” and filed on May 15, 2023, which is expressly incorporated by reference herein in its entirety.

### TECHNICAL FIELD

The present disclosure relates generally to communication systems, and more particularly, to a carrier phase positioning (CPP) system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The UE may include a positioning reference unit (PRU). The apparatus may receive a configuration message including a timing window (TW) configuration for a set of positioning measurements on a set of positioning signals. The apparatus may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The apparatus may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The apparatus may receive the set of positioning signals. The apparatus may perform the set of positioning measurements on the set of positioning signals during a TW that is less than or equal to the measurement period. The apparatus may transmit a report message including the measured set of positioning measurements.

In an aspect of the disclosure, a method, a computer-readable medium, and an apparatus are provided. The apparatus may include a network entity. The network entity may include a wireless device of a core network, for example a set of location servers or a location management function (LMF). The apparatus may transmit a configuration message including a TW configuration for a set of positioning measurements on a set of positioning signals. The apparatus may receive a report message including the set of positioning measurements on the set of positioning signals based on a measurement period associated with the TW configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5 is a diagram illustrating another example of positioning based on positioning signal measurements.

FIG. 6 is a diagram illustrating an example of a schedule of a set of positioning signals relative to a measurement period for measuring the set of positioning signals.

FIG. 7 is a diagram illustrating an example of a configuration for measuring a set of positioning signals with a timing window (TW) configuration.

FIG. 8 is a diagram illustrating an example of a set of positioning signals relative to different scheduled TWs.

FIG. 9 is a connection flow diagram illustrating an example of a wireless device configured to measure a set of positioning signals based on a TW configuration.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A first wireless device, such as a user equipment (UE), may be configured to measure a set of positioning signals transmitted by a second wireless device, such as a network node. The first wireless device may configure one or more measurement periods for measuring the set of positioning signals. During a measurement period, the first wireless device may measure the set of positioning signals transmitted by the second wireless device.

A network entity, such as a location management function (LMF), may configure the first wireless device with a timing window (TW) configuration that the first wireless device may use to measure the set of positioning signals. The TW configuration may include, for example, a start time and a length of a TW, a start time and an end time of a TW, and/or a periodicity of a TW. The TW configuration may include a set of positioning reference signal (PRS) resource identifiers (IDs), a set of resource set IDs, and/or a set of positioning frequency layer (PFL) IDs to be measured by the first wireless device. The TW configuration may include an indication of one or more types of measurements for the first wireless device to measure, for example a carrier phase measurement or a reference signal received power (RSRP) measurement. In some aspects, the first wireless device may be able to optimize the measurement period used to measure the set of positioning signals based on the TW configuration. For example, the TW configuration may reduce the time duration of available PRS in a PFL to be measured by the first wireless device. This reduced time duration may be used to optimize the measurement period used by the first wireless device to measure the set of positioning signals.

Various aspects relate generally to performing positioning on wireless devices. Some aspects more specifically relate to calculating a measurement period used by a wireless device to measure positioning signals received by the wireless device. In some examples, a user equipment (UE) may receive a configuration message including a timing window (TW) configuration for a set of positioning measurements on a set of positioning signals. The apparatus may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The apparatus may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The apparatus may receive the set of positioning signals. The apparatus may perform the set of positioning measurements on the set of positioning signals during a TW that is less than or equal to the measurement period. The apparatus may transmit a report message including the measured set of positioning measurements.

Particular aspects of the subject matter described in this disclosure can be implemented to realize one or more of the following potential advantages. In some examples, by calculating a measurement period a set of positioning measurements based on a TW configuration, or on a value calculated based on the TW configuration, the described techniques can be used to optimize the length of a measurement period used by a UE to measure a set of positioning signals. The length of the measurement period may be reduced as compared with a measurement period calculated without taking the TW configuration into account.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

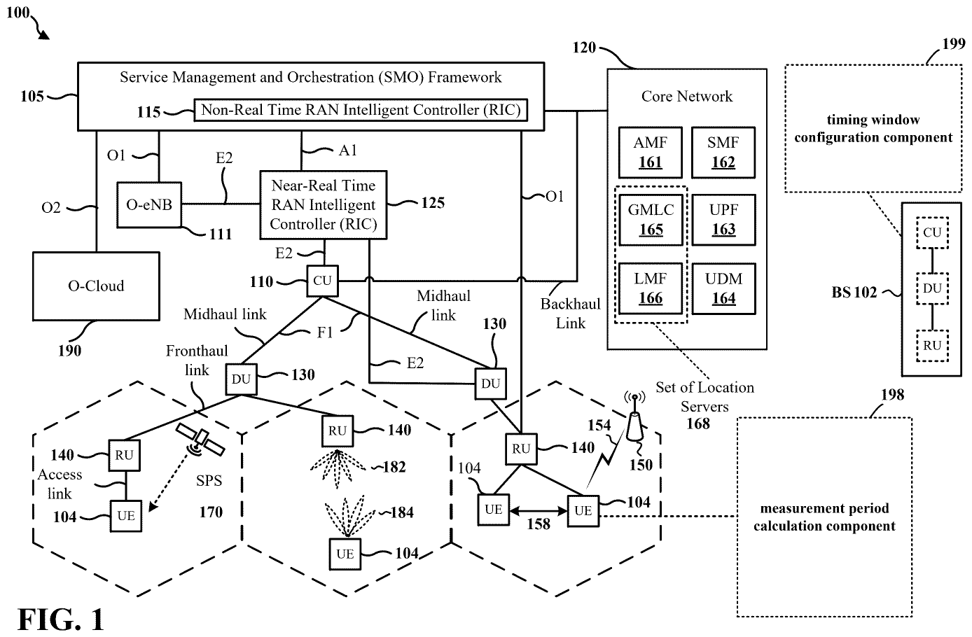

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a measurement period calculation component 198 that may be configured to receive a configuration message including a TW configuration for a set of positioning measurements on a set of positioning signals. The measurement period calculation component 198 may be configured to calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The measurement period calculation component 198 may be configured to calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The measurement period calculation component 198 may be configured to receive the set of positioning signals. The measurement period calculation component 198 may be configured to perform the set of positioning measurements on the set of positioning signals during a TW that is less than or equal to the measurement period. The measurement period calculation component 198 may be configured to transmit a report message including the measured set of positioning measurements. In certain aspects, the base station 102, such as the core network 120, the one or more location servers 168, or the LMF 166, may have a timing window configuration component 199 that may be configured to transmit a configuration message including a TW configuration for a set of positioning measurements on a set of positioning signals. The timing window configuration component 199 may be configured to receive a report message including the set of positioning measurements on the set of positioning signals based on a measurement period associated with the TW configuration. In summary, the timing window configuration component 199 of a base station 102 may configure a TW configuration for a UE 104. The timing window configuration component 199 may transmit the TW configuration to the UE 104. The measurement period calculation component 198 of the UE 104 may then calculate one or more variables based on the TW configuration, such as a time duration of available positioning signals of the set of positioning signals, a periodicity of the set of positioning measurements, and/or a number of instances of the set of positioning signals associated with a carrier phase measurement of the set of positioning measurements based on the TW configuration. The measurement period calculation component 198 may calculate a measurement period based on the previous calculation, thereby optimizing the length of the measurement period. The measurement period calculation component 198 may perform a set of positioning measurements on the set of positioning signals, ensuring that the measurement period used to measure the set of positioning signals does not exceed the calculated measurement period. The measurement period calculation component 198 may transmit a report message that includes the measured set of positioning measurements.

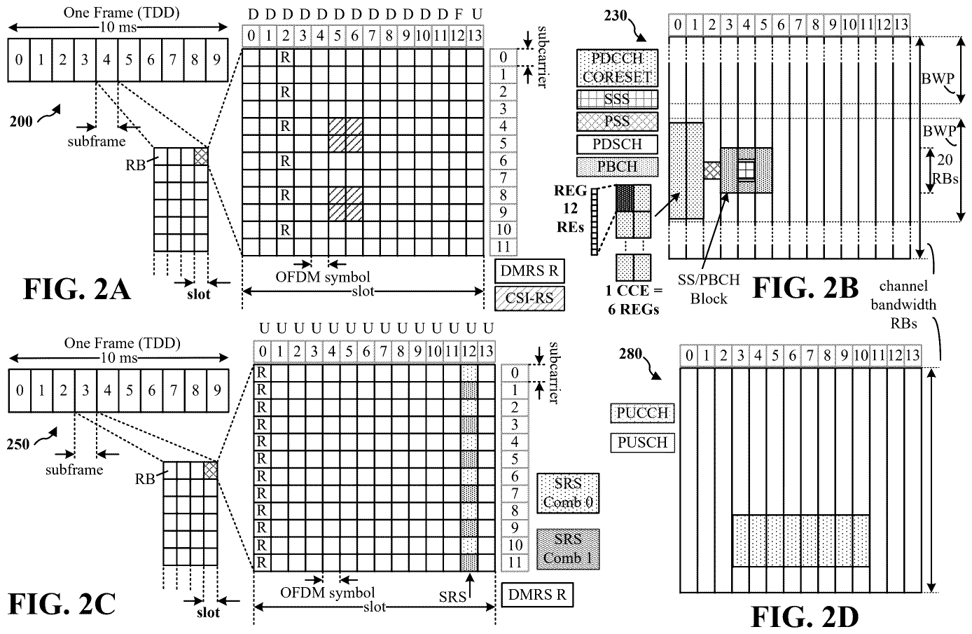

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

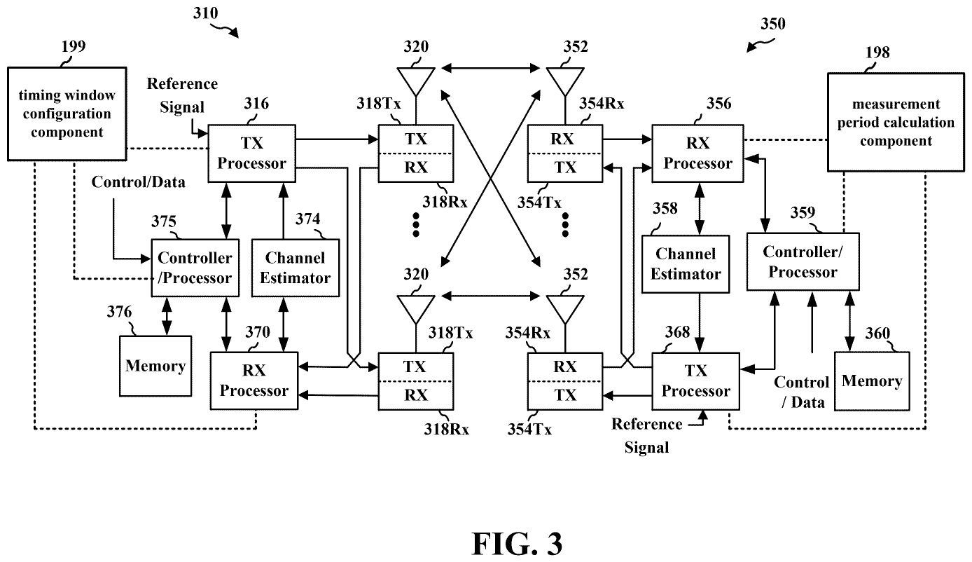

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement period calculation component 198 of FIG. 1.

At least one of the TX processor 316, the RX processor 370, and the controller/processor 375 may be configured to perform aspects in connection with the timing window configuration component 199 of FIG. 1.

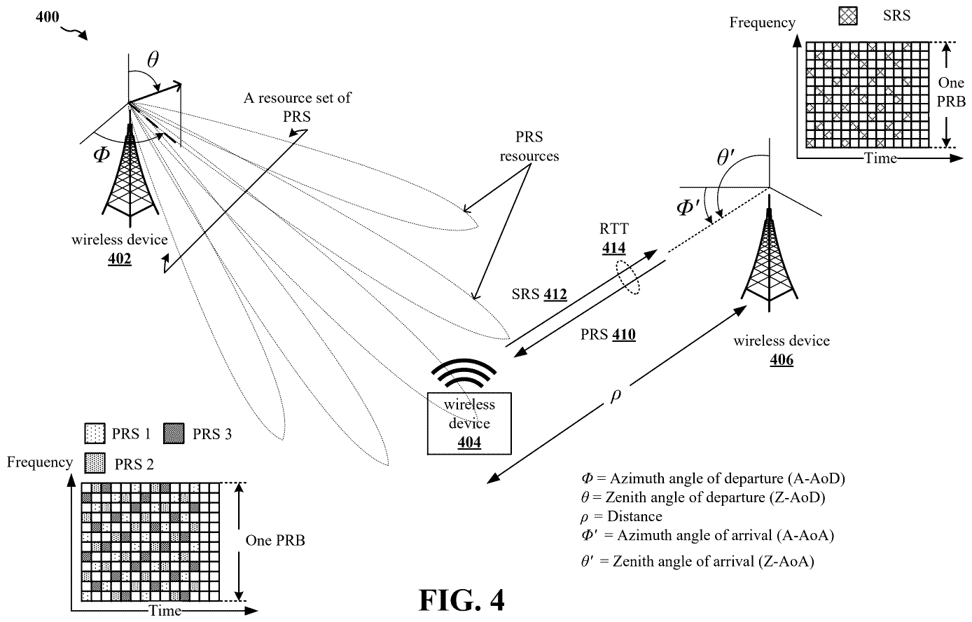

FIG. 4 is a diagram 400 illustrating an example of positioning based on reference signal measurements. The wireless device 402 may be a UE, a base station, or a positioning reference unit (PRU). The wireless device 404 may be a UE, a base station, or a PRU. The wireless device 406 may be a UE, a base station, or a PRU. The wireless device 402 may be referred to as a positioning target wireless device, whose location may be calculated based on measurements of one or more reference signals. The wireless device 404 and the wireless device 406 may be referred to as positioning neighbor wireless devices, whose locations may be known, which may be used to calculate the location of the wireless device 402. The wireless device 404 may transmit SRS 412 at time T_{SRS_TX} to the wireless device 406. The wireless device 404 may receive positioning reference signals (PRS) 410 at time T_{PRS_RX} from the wireless device 406. The SRS 412 may be an UL-SRS. The PRS 410 may be a DL-PRS. In some aspects, the wireless device 402 may be a TRP and the wireless device 406 may be a TRP, which may be both configured to transmit DL-PRS to the wireless device 404. The wireless device 404 may be a UE configured to transmit UL-SRS to the wireless device 402 and the wireless device 406.

The wireless device 406 may receive the SRS 412 at time T_{SRS_RX} from the wireless device 404 and transmit the PRS 410 at time T_{PRS_TX} to the wireless device 404. The wireless device 404 may receive the PRS 410 before transmitting the SRS 412. The wireless device 404 may transmit the SRS 412 before receiving the PRS 410. The wireless device 404 may transmit the SRS 412 in response to receiving the PRS 410. The wireless device 406 may transmit the PRS 410 in response to receiving the SRS 412. A positioning server (e.g., location server(s) 168), the wireless device 404, or the wireless device 406 may determine the round-trip-time (RTT) 414 based on ∥T_{SRS_RX}−T_{PRS_TX}|−|T_{SRS_TX}−T_{PRS_RX}∥. Multi-RTT positioning may make use of the Rx-Tx time difference measurements (i.e., |T_{SRS_TX}−T_{PRS_RX}|) and PRS reference signal received power (RSRP) (PRS-RSRP) of PRS signals received from multiple wireless devices, such as the wireless device 402 and the wireless device 406, which are measured by the wireless device 404, and the measured Rx-Tx time difference measurements (i.e., |T_{SRS_RX}−T_{PRS_TX}|) and SRS-RSRP at multiple wireless devices, such as at the wireless device 402 and at the wireless device 406 of SRS transmitted from wireless device 404. The wireless device 404 may measure the Rx-Tx time difference measurements, and/or PRS-RSRP of the received signals, using assistance data received from the positioning server, the wireless device 402, and/or the wireless device 406. The wireless device 402 and the wireless device 406 may measure the Rx-Tx time difference measurements, and/or SRS-RSRP of the received signals, using assistance data received from the positioning server. The measurements may be used at the positioning server or the wireless device 404 to determine the RTT, which may be used to estimate the location of the wireless device 404. Other methods are possible for determining the RTT, such as for example using time-difference of arrival (TDOA) measurements, such as DL-TDOA and/or UL-TDOA measurements.

DL-AoD positioning may make use of the measured PRS-RSRP of signals transmitted from multiple wireless devices, such as the wireless device 402 and the wireless device 406, and received at the wireless device 404. The AoD positioning may also be referred to as DL-AoD positioning where the PRS are DL signals. The wireless device 404 may measure the PRS-RSRP of the received signals using assistance data received from the positioning server, and the resulting measurements may be used along with the azimuth angle of departure (A-AoD), the zenith angle of departure (Z-AoD), and other configuration information to locate the wireless device 404 in relation to the neighboring wireless devices that transmitted the PRS, such as the wireless device 402 and the wireless device 406.

DL-TDOA positioning may make use of the DL reference signal time difference (RSTD), and/or PRS-RSRP of signals received from multiple wireless devices, such as the wireless device 402 and the wireless device 406, at the wireless device 404. The wireless device 404 may measure the RSTD, and/or the PRS-RSRP, of the received PRS signals using assistance data received from the positioning server, and the resulting measurements may be used along with other configuration information to locate the wireless device 404 in relation to the neighboring wireless devices that transmitted the PRS, such as the wireless device 402 and the wireless device 406.

UL-TDOA positioning may make use of the UL relative time of arrival (RTOA), and/or SRS-RSRP, at multiple wireless devices, such as the wireless device 402 and the wireless device 406, of signals transmitted from the wireless device 404. The wireless devices, such as the wireless device 402 and the wireless device 406, may measure the RTOA, and/or the SRS-RSRP, of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices, such as the wireless device 402 and the wireless device 406, of signals transmitted from the wireless device 404. The wireless device 402 and the wireless device 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UL-AoD and/or DL-AoA at the wireless device 404. Note that data/measurements from various technologies may be combined in various ways to increase accuracy, to determine and/or to enhance certainty, to supplement/complement measurements, and/or to substitute/provide for missing information.

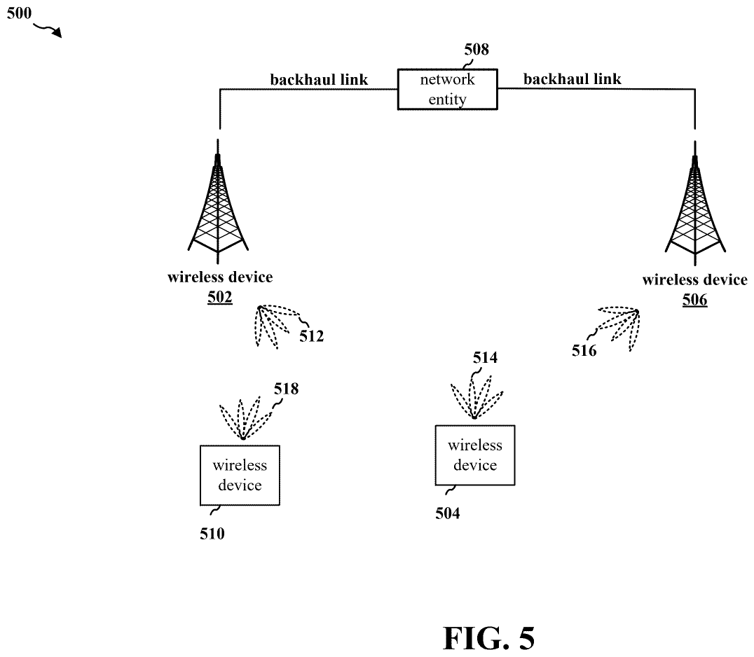

FIG. 5 is a diagram 500 illustrating a network entity 508 that may be configured to coordinate a wireless device 502 and a wireless device 506 to perform positioning with a wireless device 504 and/or to perform positioning with a wireless device 510. The location of the wireless device 502 and the wireless device 506 may be known to at least one device, such as the wireless device 502, the wireless device 504, the wireless device 506, and/or the network entity 508. The wireless device 502 may be a base station, a gNB, or a TRP. The wireless device 506 may be a base station, a gNB, or a TRP. The wireless device 504 may be a UE or a PRU. The wireless device 510 may be a UE or a PRU. A PRU may be a UE with a known location. For example, the PRU may be fixed in place, or may be placed in a known location for calibration purposes. The PRU may have a set of high-accuracy sensors that identify the location of the PRU with a degree of accuracy greater than or equal to a minimum threshold value. The PRU may be used for calibration purposes with a UE. For example, where both the PRU and the UE measure the same set of positioning signals, the measurements of the PRU may be used to calculate a group delay or synchronization problems with the UE. In some aspects, the location of the UE with respect to the known location of the PRU may be calculated based on differences between measurements of the UE and measurements of the PRU on the same set of positioning signals. The network entity 508 may be connected to the wireless device 502 and the wireless device 506 via a physical link, for example a backhaul link or a midhaul link, or via a wireless link, such as an air interface (UE-UTRAN (Uu)) link. The network entity 508 may be part of a core network, such as an LMF or a set of location servers. The network entity 508 may configure positioning occasions between the wireless device 502, the wireless device 504, and the wireless device 506. The network entity 508 may configure positioning occasions between the wireless device 502, the wireless device 504, and the wireless device 510.

To perform positioning, the network entity 508 may configure the wireless devices to transmit positioning signals at one another. For example, the wireless device 504 may transmit the set of positioning signals 514 at the wireless device 502 and/or at the wireless device 506. The set of positioning signals 514 may include a set of SRSs, SSBs, or CSI-RSs. The wireless device 502 may measure the set of positioning signals 514. The wireless device 506 may measure the set of positioning signals 514. The wireless device 510 may transmit the set of positioning signals 518 at the wireless device 502 and/or at the wireless device 506. The set of positioning signals 518 may include a set of SRSs, SSBs, or CSI-RSs. The wireless device 502 may measure the set of positioning signals 518. The wireless device 506 may measure the set of positioning signals 518. The wireless device 502 may transmit the set of positioning signals 512 at the wireless device 504 and/or at the wireless device 510. The set of positioning signals 512 may include a set of PRSs, SSBs, or CSI-RSs. The wireless device 504 may measure the set of positioning signals 512. The wireless device 510 may measure the set of positioning signals 512. The wireless device 506 may transmit a set of positioning signals 516 at the wireless device 504 and/or at the wireless device 510. The set of positioning signals 516 may include a set of PRSs, SSBs, or CSI-RSs. The wireless device 504 may measure the set of positioning signals 516. The wireless device 510 may measure the set of positioning signals 516.

One or more of the wireless devices may measure the received positioning signals to calculate a positioning measurement that may be used to calculate a location of the wireless device 504, may be used to calculate a position or a location of the wireless device 504, may be used to calculate a location of the wireless device 510, and/or may be used to calculate a position or a location of the wireless device 510. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known. In another example, the wireless device 510 may include a PRU with a known location and the wireless device 504 may include a UE with an unknown location. The wireless device 510 may measure the time of arrival of the set of positioning signals 512 and the set of positioning signals 516, and may transmit the recorded times to the wireless device 504, or may transmit the recorded times to the network entity 508 for transmission to the wireless device 504. The wireless device 504 may measure a RSTD between when the wireless device 510 received the set of positioning signals 512 and when the wireless device 504 received the set of positioning signals 512, and may measure a RSTD between when the wireless device 510 received the set of positioning signals 516 and when the wireless device 504 received the set of positioning signals 516. The wireless device 504 may then calculate a position of the wireless device 504 relative to the known location of the wireless device 510. In another example, the wireless device 510 may include a PRU with a known location and the wireless device 504 may include a UE with an unknown location. The wireless device 510 may measure a RSTD between the time of arrival of the set of positioning signals 512 and the set of positioning signals 516. The wireless device 504 may measure a RSTD between the time of arrival of the set of positioning signals 512 and the set of positioning signals 516. One of the wireless devices (e.g., the wireless device 504 or the network entity 508) may then calculate a location of the wireless device 504 relative to the known location of the wireless device 510 based on the difference between the RSTD measured at the wireless device 510 and the RSTD measured at the wireless device 504.

Other measurements, RTOA, line-of-sight (LOS) identification (identifying whether there is a direct line-of-sight path between wireless devices), non-line of sight (NLOS) identification, multi-cell round trip time (multi-RTT) calculations, carrier phase positioning (CPP), TDOA, RSTD, RSRP, RSRP path (RSRPP), reception transmission (Rx-Tx), non-line of sight (NLOS) identification, and/or quality indication calculations may be performed to calculate the position/location of the wireless device 504 and/or the wireless device 510, or to calculate a measurement that may be used to calculate the position/location of the wireless device 504 and/or the wireless device 510.

In some aspects, a positioning model may be used to calculate one or more positioning metrics based on the measurements. For example, based on the measurements of the set of positioning signals 516 and/or the set of positioning signals 518 by the wireless device 504, a position of the wireless device 504 may be calculated or estimated, or an intermediate measurement that may be used to calculate the location of the wireless device 504 may be calculated or estimated. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, or a CSI-RS. A positioning signal transmitted from a network node, such as a TRP or a base station, may be referred to as a downlink positioning signal, or a DL-positioning signal. A measurement may be a channel impulse response (CIR) or other measurement used for performing positioning on a target wireless device. A label may be a calculated, derived, or given (i.e., known) expected result associated with a set of inputs, such as a location of a wireless device 504 or an intermediate measurement (e.g., a timing measurement, an angle measurement, a LOS identification) that may be used to calculate the location of the wireless device 504. A set of inputs and a set of labels may be used for generating and/or training a positioning model using AI/ML.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 504 may have a positioning model configured to accept a set of positioning measurements and generate an estimate of a location of the wireless device 504. In another example, the wireless device 504 may have a positioning model configured to accept a set of positioning measurements and generate an intermediate measurement (e.g., a timing measurement, an angle measurement, a LOS identification) that may be used (by the wireless device 504, or another entity, such as the network entity 508, the wireless device 502, or the wireless device 506) to calculate the location of the wireless device 504. In another example, the wireless device 502 or the wireless device 506 may have a positioning model configured to accept a set of positioning measurements and generate an estimate of a location of the wireless device 504. In another example, the wireless device 502 or the wireless device 506 may have a positioning model configured to accept a set of positioning measurements and generate an intermediate measurement that may be used to calculate the location of the wireless device 504. In another example, the network entity 508 may have a positioning model configured to accept a set of positioning measurements and generate an estimate of a location of the wireless device 504. In some aspects, the positioning measurements may be measured by the entity with the positioning model, for example the wireless device 504 may measure the set of positioning signals 516 and may measure the set of positioning signals 518, and may use those measurements as inputs to a positioning model at the wireless device 504. In some aspects, the positioning measurements may be measured and aggregated by the entity with the positioning model, for example the wireless device 502 may measure the set of positioning signals 512, and may aggregate measurements from the wireless device 506 and/or the wireless device 504 to use as inputs to a positioning model. In some aspects, the positioning measurements may be aggregated by the entity with the positioning model. For example, the network entity 508 may aggregate measurements from the wireless device 502, the wireless device 504, and the wireless device 506 to use as inputs to a positioning model.

A positioning model may be trained on a wireless device that performs positioning, such as the wireless device 502, the wireless device 504, the wireless device 506 and/or the network entity 508, or may be trained on an offline device, such as an over-the-top (OTT) server. The inputs to the positioning model may include measurements of positioning signals, such as measurements of SRS, PRS, SSB, and/or CSI-RS. The inputs to the measurements may include assistance information associated with the measured positioning signals, such as BWP of a positioning signal resource, number of TRPs, beam information, positioning signal configuration). The labels/outputs for the positioning model may include a location, or an intermediate measurement.

In some aspects, a positioning model may be configured to use measurements of DL-positioning signal transmitted from one or more network nodes to calculate a position of the wireless device 504, or to calculate an intermediate measurement that may be used to calculate the position of the wireless device 504. The positioning model may be trained via a training entity, and may be used at the wireless device 504 or the network entity 508. For example, a positioning model at the wireless device 504 may be configured to calculate the location of the wireless device 504 based on measurements of the set of positioning signals 516 and the set of positioning signals 518. In another example, a positioning model at the wireless device 504 may be configured to calculate a set of intermediate measurements based on measurements of the set of positioning signals 516 and the set of positioning signals 518. The wireless device 504 may transmit the set of intermediate measurements to the network entity 508 so that the network entity 508 may calculate the location of the wireless device 504 based on the set of intermediate measurements. In another example, the wireless device 504 may transmit measurements of the set of positioning signals 516 and the set of positioning signals 518 to the network entity 508. The positioning model may be at the network entity 508. The positioning model at the network entity 508 may calculate the location of the wireless device 504 based on the transmitted measurements of the set of positioning signals 516 and the set of positioning signals 518.

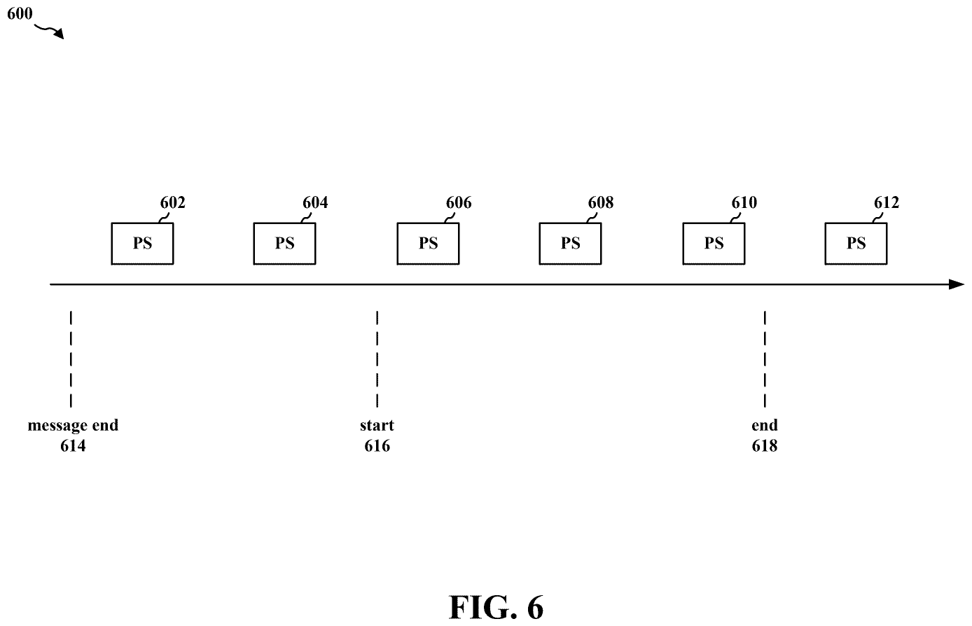

FIG. 6 is a diagram 600 illustrating a schedule of a set of positioning signals transmitted from a wireless device, for example the positioning signal 602, the positioning signal 604, the positioning signal 606, the positioning signal 608, the positioning signal 610, and the positioning signal 612. A positioning signal may be, for example, an SRS, a PRS, an SSB, or a CSI-RS. A set of positioning signals may be transmitted periodically, for example every 0.5 ms, for a period of time, allowing a wireless device to measure some of the set of positioning signals to obtain an accurate measurement of the set of positioning signals.

In some aspects, the wireless device that measures the set of positioning signals may receive a message from a device scheduling the set of positioning signals, for example a network entity (e.g., a set of location servers, an LMF) or a network node (e.g., a base station, a TRP). The message may include, for example, a long-term evolution (LTE) positioning protocol (LPP) message. The message may include assistance data for the set of positioning signals (e.g., an NR-Multi-RTT-ProvideAssistanceData message) or a request for location information using the set of positioning signals (e.g., an NR-Multi-RTT-RequestLocationInformation message). After receiving the message, the UE may measure the set of positioning signals. The end of such a message (e.g., the end of a received NR-Multi-RTT-RequestLocationInformation message or of a received NR-Multi-RTT-ProvideAssistanceData message) is shown in FIG. 6 as the message end time 614.

The wireless device that measures the set of positioning signals may be configured to measure multiple measurements, for example some of the set of positioning signals, up to a maximum UE capability to measure multiple measurements. In one aspect, the UE may be configured to measure Rx-Tx time difference measurements in one or more configured PFLs within a measurement period. A measurement period for a PFL may start from a first measurement gap (MG) instance aligned with a resource of a positioning signal for the PFL closest in time after the end of a message is delivered to the physical later of the UE, such as the message end time 614. A length of a measurement gap may also be referred to as a measurement gap length (MGL).

The message may indicate a measurement window. For example, an NR-Multi-RTT-RequestLocationInformation message may include a start time (e.g., a startMeasurementTime indicated in a RequestLocationInformation message), shown as the start time 616, and an end time (e.g., an endMeasurementTime indicated in a RequestLocationInformation message), shown as the end time 618. A message may not include a specific measurement window. A UE that uses an indicated measurement window with the start time 616 and the end time 618 may measure the positioning signal 606, the positioning signal 608, and the positioning signal 610 using the indicated measurement window, but may not measure the positioning signal 602, the positioning signal 604, or the positioning signal 612, as those positioning signals are received by the UE outside of the indicated measurement window. In other words, the measurement window for a PFL may start from the first measurement gap instance aligned with a resource of a positioning signal of the PFL closest in time after a received message (e.g., the end of a received NR-Multi-RTT-RequestLocationInformation message and/or of a received NR-Multi-RTT-ProvideAssistanceData message) and after the start time indicated in such a message (e.g., the startMeasurementTime indicated in a RequestLocationInformation message).

In some aspects, an LMF may be configured to request a set of UEs to perform measurements on a set of positioning signals, which may be indicated in the request), occurring within a set of indicated time windows. For example, with respect to FIG. 5, the network entity 508 may request the wireless device 504 and the wireless device 510 to perform measurements on the set of positioning signals 512 and/or the set of positioning signals 516 occurring within a set of indicated time windows. The request may indicate a set of resources, for example a set of DL PRS resources. The indication may include, for example, a set of PRS IDs, a set of resource set IDs, and/or a set of PFL IDs. Such a configuration may include the indicated set of time windows (e.g., start time, duration, end time, periodicity). Such a configuration may include a relationship with a scheduled location time, such as a relationship between a type of measurement and a scheduled location time, or a relationship between a UE ID and a scheduled location time. The request may be broadcast to a plurality of UEs simultaneously, enabling the plurality of UEs (e.g., a UE and a PRU) to simultaneously measure the same set of positioning signals. Such a request may be transmitted in a message that includes a timing window (TW) configuration that includes configuration information regarding such a measurement window.

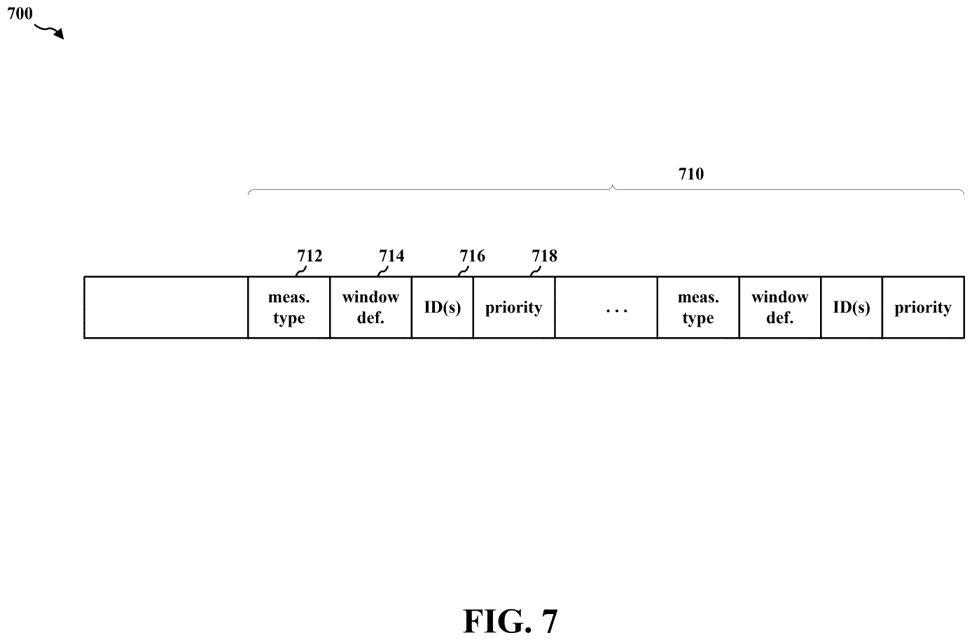

FIG. 7 is a diagram illustrating a message 700 that includes a TW configuration 710 for measuring a set of positioning signals. The message may include, for example, assistance data information for a set of positioning signals or a request for location information from a set of UEs (e.g., a NR-Multi-RTT-RequestLocationInformation message or a NR-Multi-RTT-ProvideAssistanceData message).

The TW configuration 710 may include an indication 712 of a set of measurement types for a set of UEs to measure. The set of measurement types may include, for example, (a) a carrier phase positioning (CPP) measurement, (b) a time difference of arrival (TDOA) measurement, (c) a reference signal time difference (RSTD) measurement, (d) a reference signal received power (RSRP) measurement, (e) a RSRP path (RSRPP) measurement, (f) a reception transmission (Rx-Tx) measurement, (g) an angle of arrival (AoA) measurement, (h) a line of sight (LOS) indication measurement, (i) a non-line of sight (NLOS) indication measurement, or (j) a quality indication measurement.

The TW configuration 710 may include an indication 714 of a set of window definitions for the set of measurement types. The set of window definitions may include a set of start times for TWs and corresponding lengths for each TW. The set of window definitions may include, a set of start times for TWs and corresponding end times for each TW. The set of window definitions may include a periodicity, for example a repetition of 10 times every 0.5 ms, or a repetition of 5 times every 1.5 ms.

The TW configuration 710 may include an indication 716 of a set of IDs that correspond with a set of measurements. The IDs may include, for example, a resource ID (e.g., a PRS resource ID), a resource set ID (e.g., a PRS resource set ID), a PFL ID, and/or a UE ID.

The TW configuration 710 may include an indication 718 of a priority associated with a set of measurements. The UE that receives the TW configuration 710 may be configured to measure the set of measurements if the priority is greater than or equal to a threshold value (i.e., a high priority).

In some aspects, the TW configuration 710 may have one set of indications for a set of measurements, whereas in other aspects the TW configuration 710 may have a plurality of sets of indications for a set of measurements. For example, the TW configuration 710 may have a set of indications for a CPP measurement and another set of indications for an RSRP measurement. In another example, the TW configuration 710 may have a set of indications for a first PFL and another set of indications for a second PFL. In some aspects, the TW configuration may have four sets of indications, one for each of four PFLs.

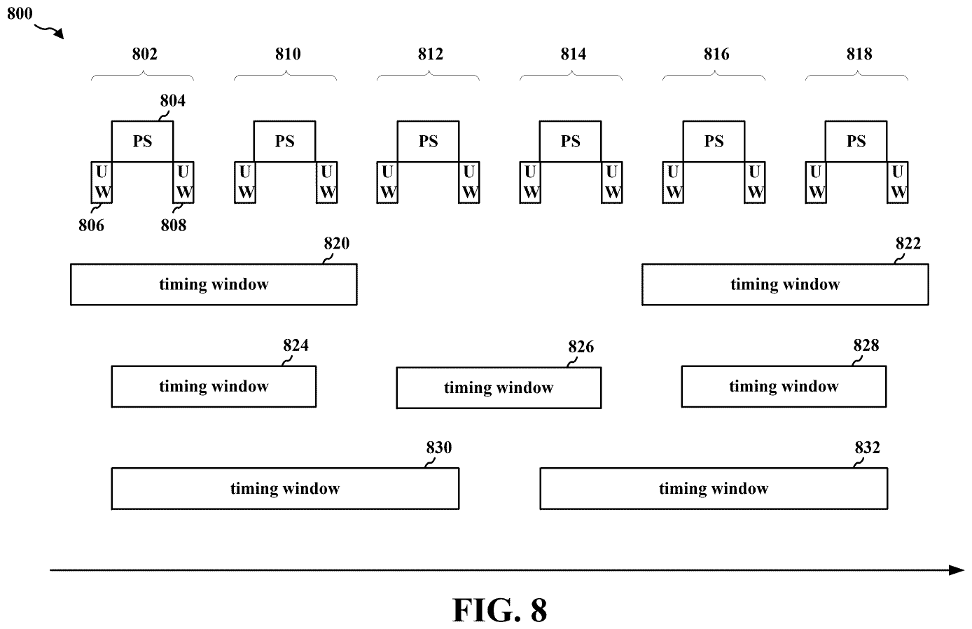

FIG. 8 is a diagram 800 illustrating a schedule of a set of effective positioning signal time domains transmitted from a wireless device, for example the positioning signal time domain 802, the positioning signal time domain 810, the positioning signal time domain 812, the positioning signal time domain 814, the positioning signal time domain 816, and the positioning signal time domain 818. A positioning signal time domain includes a positioning signal and an uncertainty window before the positioning signal and an uncertainty window after the positioning signal. For example, the positioning signal time domain 802 may include a positioning signal 804, an uncertainty window 806 before the positioning signal 804, and an uncertainty window 808 after the positioning signal 804. The uncertainty window may be defined by a condition or a specification associated with the UE, for example 0.2 ms or three symbols, which may be a buffer before and after the positioning signal which the UE may use to minimize errors with measuring the positioning signal. In some aspects, the uncertainty may be provided in a configuration, for example taking into account the variables NR-DL-PRS-ExpectedRSTD-Uncertainty and/or NR-DL-PRS-ExpectedRSTD.

In some aspects, an instance of a set of positioning signals may include a plurality of positioning signal time domains. For example, an instance of a set of positioning signals may include two consecutive positioning signals, or two consecutive positioning signal time domains. A first instance may include the positioning signal time domain 802 and the positioning signal time domain 810, a second instance may include the positioning signal time domain 812 and the positioning signal time domain 814, and a second instance may include the positioning signal time domain 816 and the positioning signal time domain 818. In another example, an instance of a set of positioning signals may include three consecutive positioning signals, or three consecutive positioning signal time domains. A first instance may include the positioning signal time domain 802, the positioning signal time domain 810, and the positioning signal time domain 812. A second instance may include the positioning signal time domain 814, the positioning signal time domain 816, and the positioning signal time domain 818. In other aspects, an instance of a set of positioning signals may include one positioning signal, or one positioning signal time domain. A first instance may include the positioning signal time domain 802. A second instance may include the positioning signal time domain 810. A third instance may include the positioning signal time domain 812. A fourth instance may include the positioning signal time domain 814. A fifth instance may include the positioning signal time domain 816. A sixth instance may include the positioning signal time domain 818.

A set of timing windows defined for a set of positioning signals may be considered at least partially overlapped with a resource of the set of positioning signals if at least one effective positioning signal time domain fully overlaps with at least one of the set of timing windows. For example, a PRS resource may be considered to be fully overlapped with a TW if all of its instances are overlapped with a TW occasion, and a PRS resource may be considered to be partially overlapped with a TW if some of its instances are overlapped with a TW occasion. In another example with respect to FIG. 8, the set of timing windows that include the timing window 820 and the timing window 822 may partially overlap with four resources of the set of positioning signals. In other words, four resources of the set of positioning signals fully overlap with the set of timing windows that include the timing window 820 and the timing window 822, as evidenced by the positioning signal time domain 802 and the positioning signal time domain 810 fully overlapping with the timing window 820 and the positioning signal time domain 816 and the positioning signal time domain 818 fully overlapping with the timing window 822. Two resources of the set of positioning signals do not fully overlap with the set of timing windows that include the timing window 820 and the timing window 822 as evidenced by the positioning signal time domain 812 and the positioning signal time domain 814 not overlapping with either of the set of timing windows that include the timing window 820 and the timing window 822.

In another example, the set of timing windows that include the timing window 824, the timing window 826, and the timing window 828 may not overlap with any of the resources of the set of positioning signals. In other words, no resources of the set of positioning signals fully overlap with the set of timing windows that include the timing window 824, the timing window 826, and the timing window 828.

In another example, the set of timing windows that include the timing window 830 and the timing window 832 may partially overlap with two resources of the set of positioning signals. In other words, two resources of the set of positioning signals fully overlap with the set of timing windows that include the timing window 830 and the timing window 832, as evidenced by the positioning signal time domain 810 fully overlapping with the timing window 830 and the positioning signal time domain 816 fully overlapping with the timing window 832.

In some aspects, a positioning signal resource instance may be considered to be overlapped with a TW occasion if a minimum number of unmuted repetitions of the instance is fully covered by the length of the TW. The minimum number may be provided in a configuration, for example accuracy conditions provided by a wireless device. A set of accuracy conditions may be associated with a measurement type, for example an RSTD measurement, an RSRP measurement, a PRS-RSRP measurement, a UE Rx-Tx time difference measurement, an RSRPP measurement, and/or a PRS-RSRPP measurement.

For example, if a positioning signal resource instance is considered a single positioning signal time domain, and a minimum number of unmuted repetitions of the instance is two, the positioning signal resource instances of the positioning signal time domain 810 and the positioning signal time domain 816 may be considered to be overlapped with the TW occasion of the timing window 830 and the timing window 832 (two is greater or equal than two), and the positioning signal resource instances of the positioning signal time domain 802, the positioning signal time domain 810, the positioning signal time domain 816, and the positioning signal time domain 818, may be considered to be overlapped with the TW occasion of the timing window 820 and the timing window 822 (four is greater or equal than two), but no positioning signal resource instance of the set of positioning signals may be considered to be overlapped with the TW occasion of the timing window 824, the timing window 826, and the timing window 828.

In another example, if a positioning signal resource instance is considered two consecutive positioning signal time domains, and a minimum number of unmuted repetitions of the instance is two, the first positioning signal resource instance of the positioning signal time domain 802 and the positioning signal time domain 810 and the second positioning signal resource instance of the positioning signal time domain 816 and the positioning signal time domain 818 may be considered to be overlapped with the TW occasion of the timing window 820 and the timing window 822 (two is greater or equal than two), but no positioning signal resource instances of the set of positioning signals may be considered to be overlapped with the TW occasion of the timing window 830 and the timing window 832, and no positioning signal resource instance of the set of positioning signals may be considered to be overlapped with the TW occasion of the timing window 824, the timing window 826, and the timing window 828.

While a network entity, such as an LMF, may provide a TW configuration that indicates a measurement window, or a timing window, which a wireless device may use to measure a set of measurements of a set of positioning signals, the wireless device may optimize a measurement period for at least one of the set of measurements of the set of positioning signals by calculating one or more measurement period variables based on the TW configuration.

In some aspects, a UE may be configured to measure multiple measurements (up to a UE capability) during a measurement period T_{meas_Total}. T_{meas_Total} may be defined as:

$${T}_{meas \_ Total} = {\sum }_{i = 1}^{L} {T}_{i} + ( L - 1 ) * max ( {T}_{effect , i} )$$

i may be the index of the PFL;
L may be the total number of PFLs for a measurement;
T_{effect,i} may be the periodicity of the positioning signal in the PFL i.

In some aspects, T_{meas_Total} may be the same for each of a set of measurements of a set of positioning signals. For example, where a TW configuration includes one set of indications (e.g., the TW configuration 710 in FIG. 7 has one indication of a set of measurement types, one indication of a set of window definitions for the set of measurement types, and one indication of a set of PRS resource IDs), T_{meas_Total} may be the same for all measurement types (e.g., an AoA measurement and an RSRP measurement) in a set of measurements for a set of positioning signals. In other aspects, T_{meas_Total} may be different for different types of measurements on a set of positioning signals. For example, where a TW configuration includes a different set of indications for different measurement types (e.g., a first set of indications for a CPP measurement, a second set of indications for an RSTD measurement, and a third set of indications for an RSRP measurement), the UE may calculate three different T_{meas_Total} measurement periods (e.g., a T_{CPP_Total}, a T_{RSTD_Total}, and a T_{RSRP_Total}), and may use the longest of the calculated measurement periods to measure the set of positioning signals.

T_{meas_i} may be the measurement period for a positioning signal measurement in a PFL i. T_{meas_i} may be defined as:

$${T}_{meas \_ i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i}$$

N_{RxBeam,i} may be a UE Rx beam sweeping factor.

In FR1, N_{RxBeam,i} may be defined to be 1.

In FR2, N_{RxBeam,i} may be calculated based on a UE capability and/or a configuration from a network entity. In one example, a UE may have a UE capability that indicates that the UE supports a lower Rx beam sweeping factor than 8 for FR2. (e.g., a UE capability may have a variable supportedLowerRxBeamSweepingFactor-FR2 that enumerates a number of Rx beam sweeping factors that the UE supports). The UE may support the capability for the band containing PFL i. In one example, a network entity may indicate an Rx beam sweeping factor. (e.g., an LMF may indicate a variable lowerRxBeamSweepingFactor-FR2 in an NR-TDOA-RequestLocationInformation message).

In other aspects, N_{RxBeam,i} may be assigned a static value, such as 8.

CSSF_{PRS,i} may be a carrier-specific scaling factor. For example, CSSF_{PRS,i} may be a carrier-specific scaling factor for NR PRS-based positioning measurements for PFL i.

k_{multiTEG,i} may be another scaling factor. For example, k_{multiTEG,i} may be a scaling factor for measurement of a same PRS resource with multiple Rx timing error groups (TEGs).

In other aspects, k_{multiTEG,i} may be assigned a static value, such as 1. k_{multiTEG,i} may be assigned such a value in response to the UE not receiving a type of request (e.g., if the UE is not requested by the network entity to measure a PRS resource with multiple Rx TEGs).

In some aspects, k_{multiTEG} may be assigned to be equal to a number of Rx TEGs associated with a request configuration. For example, k_{multiTEG} may be assigned to be equal to N_{TEG,i}. N_{TEG,i} may be the number of Rx TEGs with which the UE is requested to measure a positioning signal resource indicated in an NR-TDOA-RequestLocationInformation message. In some aspects, N_{TEG,i} may be the maximum number of Rx TEGs corresponding with the UE's capability to support measuring the same positioning signal resource. k_{multiTEG} may be assigned to be equal to N_{TEG,i} if the UE does not have the UE capability of receiving the same positioning signal resource simultaneously from multiple Rx TEGs.

In other aspects, k_{multiTEG} may be calculated based on a number of Rx TEGs the UE can measure simultaneously. For example, k_{multiTEG} may be calculated as

$$⌈ \frac{{N}_{TEG , i}}{{k}_{TEG , simul , i}} ⌉$$

if the UE is capable of receiving the same positioning signal resource simultaneously from multiple Rx TEGs.

K_{p,PRS,i} may be a scaling factor. K_{p,PRS,i} may be a scaling factor for a PFL to be measured within the associated measurement gap pattern. K_{p,PRS,i} may be defined as K_{p,PRS,i}=Nₜₒₜₐₗ/N_{available} for a UE configured with a concurrent measurement gap. K_{p,PRS,i} may be defined as K_{p,PRS,i}=1 for a UE that is not configured with concurrent measurement gap. In some aspects, a window W may have a duration of the larger between T_{PRS,i} and MGRP_max (e.g., max(T_{PRS,i}, MGRP_max)). MGRP_max may be a maximum MGRP across all configured per-UE measurement gaps and per-frequency range measurement gaps within the same FR as the PFL. The window W may start at the beginning of at least one associated gap occasion that covers, or fully overlaps with, the positioning signal occasion.

Nₜₒₜₐₗ may be a total number of associated gap occasions that covers, or fully overlaps with, positioning signal occasions within the window W. The associated gap occasions may include those overlapped with other measurement gap occasions within the window W.

N_{available} may be the number of non-dropped associated gap occasions covering positioning signal occasions within the window W. The number of non-dropped associated gap occasions may further account for measurement gap collisions by applying one or more gap collision rules. The UE may select a gap collision rule from a set of gap collision rules to apply. In some aspects, the variable K_{p,PRS,i} may not apply if N_{available}=0 in order to avoid a divide by zero error.

$${N}_{PRS , i}^{slot}$$

may be a maximum number of positioning signal resources in the PFL i configured in a slot.

L_{available_PRS,i} may be defined as a time duration of available positioning signals in the PFL i to be measured during T_{available_PRS,i}. L_{available_PRS,i} may be defined in terms of a number of symbols. A UE may calculate the value of L_{available_PRS,i} based on positioning signal resources that are unmuted. A UE may calculate the value of L_{available_PRS,i} based on positioning signal resources that are fully or partially overlapped with a set of measurement gaps provided by a network. A UE may calculate the value of L_{available_PRS,i} based on positioning signal resources that are fully or partially overlapped with a set of TWs defined by the TW configuration. A UE may calculate the value of L_{available_PRS,i} based on a set of specific positioning signal resources (e.g., indicated by a set of PRS IDs), a set of specific positioning signal resource sets (e.g., indicated by a set of PRS resource set IDs), and/or a set of specific PFLs (e.g., indicated by a set of PFL IDs) that are indicated to be measured by the TW configuration. The UE may calculate the value of L_{available_PRS,i} based on any combination of the aforementioned factors.

Nₛₐₘₚₗₑ may be a number of positioning signal measurement samples. The number may refer to a number of positioning signal instances for the UE to measure. In some aspects, Nₛₐₘₚₗₑ may be set to one. For example, the UE may set Nₛₐₘₚₗₑ=1 if the UE is configured to measure a CPP. In one aspect, in response to receiving a request (e.g., from a network entity) for the UE to measure a reference signal carrier phase (RSCP) or a reference signal carrier phase difference (RSCPD) (e.g., a PRS-RSCP or a PRS-RSCPD), the UE may set Nₛₐₘₚₗₑ=1. In some aspects, in response to receiving a request for the UE to measure an RSCP or an RSCPD, the UE may set at least one measurement instance to have Nₛₐₘₚₗₑ=1 (i.e., a minimum of a single instance may be measured for a PRS-RSCP or a PRS-RSCPD, but other instances with Nₛₐₘₚₗₑ=2, 3, or 4 may be used as well). In some aspects, in response to receiving a request for the UE to measure an RSCP or an RSCPD, the UE may set at least one measurement instance associated with measured the CPP measurement to have Nₛₐₘₚₗₑ=1 and other measurement instances associated with other measurement types (e.g., DL-TDOA, RSTD, RSRP) to have Nₛₐₘₚₗₑ>1.

In some aspects, the UE may set Nₛₐₘₚₗₑ=1 if the UE has a UE capability that indicates support of measurements based on measuring one sample/instance of a positioning signal resource set (e.g., a DL-PRS resource set) (e.g., the UE may have a UE capability that indicates support for supportedDL-PRS-ProcessingSamples). In some aspects, the UE may set Nₛₐₘₚₗₑ=1 if the UE also or alternatively receives a request (e.g., a RequestLocationInformation message from an LMF) for the UE to perform positioning measurements with a reduced number of samples. In some aspects, the UE may set Nₛₐₘₚₗₑ=1 if the positioning sample bandwidth is also or alternatively within the active BWP. In some aspects, the UE may set Nₛₐₘₚₗₑ=1 if the magnitude of difference between the serving cell's SS-RSRP and the neighbour cell's PRS-RSRP is also or alternatively less than or equal to a threshold amount (e.g., 6 dB).

In some aspects, the UE may set Nₛₐₘₚₗₑ=2 if the UE support of measurements based on measuring two samples/instances of a positioning signal resource set (e.g., the UE may have a UE capability that indicates support for supportedDL-PRS-ProcessingSamples). In some aspects, the UE may set Nₛₐₘₚₗₑ=2 if the UE also or alternatively receives a request (e.g., a RequestLocationInformation message from an LMF) for the UE to perform positioning measurements with a reduced number of samples. In some aspects, the UE may set Nₛₐₘₚₗₑ=2 if the positioning sample bandwidth is also or alternatively not within the active BWP. In some aspects, the UE may set Nₛₐₘₚₗₑ=2 if the magnitude of difference between the serving cell's SS-RSRP and the neighbour cell's PRS-RSRP is also or alternatively greater than a threshold amount (e.g., 6 dB).

In some aspects, the UE may set Nₛₐₘₚₗₑ=4, for example if the above conditions are not met for a set of resources or a measurement type.

T_{last,i} may be a measurement duration for the last positioning signal sample/instance in PFL i. For example, if a UE measures two consecutive positioning signals having a length of six symbols that repeats every ten symbols, in a PFL i, T_{last,i} may be six symbols, since no positioning signal will be measured after the last positioning signal. The measurement duration may include a sampling time and/or processing time for measuring the last positioning signal sample/instance. In some aspects, T_{last,i}=Tᵢ+MGL, for example if all of the resources of a positioning signal to be measured are available in the same measurement gap occasion. In some aspects, T_{last,i}=Tᵢ+T_{available_PRS,i}.

T_{effect,i} may be a periodicity of the positioning signal measurement in PFL i. T_{effect,i} may be defined as:

$${T}_{effect , i} = ⌈ \frac{{T}_{i}}{{T}_{available \_ PRS , i}} ⌉ * {T}_{available \_ PRS , i}$$

Tᵢ may correspond with a defined duration of positioning signal symbols in units of milliseconds (ms) that the UE may process every T ms. The defined duration may assume a maximum positioning signal bandwidth in MHz. The duration may be a defined duration of a positioning signal (e.g., a PRS) in symbols, for example 8 symbols, 16 symbols, 20 symbols, 30 symbols, 40 symbols, 80 symbols, 160 symbols, 320 symbols, 640 symbols, or 1280 symbols. In some aspects, an information element may define the capability of a UE to process a positioning signal, for example in an NR-DL-PRS-ProcessingCapability message, the UE may indicate the defined duration via a durationOfPRS-ProcessingSymbolsInEveryTms variable.

T_{available_PRS,i} may be a least common multiple (LCM) of a set of values. The values may be periodic values. In some aspects, T_{available_PRS,i}=LCM(T_{PRS,i},MGRPᵢ), which may be the LCM between T_{PRS,i} and MGRPᵢ. T_{PRS,i} may be a periodicity of positioning signal resources with muting on PFL i. MGRPᵢ may be a repetition periodicity of the measurement gap applicable for measurement in the PFL i. For example, if T_{PRS,i}=80 ms and MGRPᵢ=160 ms, then the LCM may be 160 ms. In other aspects, T_{available_PRS,i}=LCM (T_{PRS,i},MGRPᵢ,TWP), which may be the LCM between T_{PRS,i}, MGRPᵢ, and TWP. TWP may be a periodicity of an indicated TW (TWP) in a TW configuration. For example, if T_{PRS,i}=80 ms, MGRPᵢ=160 ms, and TWP=320 ms, then the LCM may be 320 ms. In some aspects, a UE may calculate the value of T_{available_PRS,i} based on whether a TW configuration indicates a TWP. For example, if a TW configuration indicates a TWP for a PFL i, then T_{available_PRS,i}=LCM(T_{PRS,i},MGRPᵢ,TWP). However, if a TW configuration does not indicate a TWP for a PFL i, then T_{available_PRS,i}=LCM(T_{PRS,i},MGRPᵢ). Where a TW configuration indicates a TW, for the purpose of calculating T_{PRS,i}, the UE may consider positioning signal resources that are fully or partially covered by the TW, and may not consider positioning signal resources that are not fully or partially covered by the TW. In other aspects, a TW may be scheduled during an RRC inactive state of the UE. In such aspects, T_{available_PRS,i} may be calculated based on a discontinuous reception period of the UE. In other words, T_{available_PRS,i}=LCM(T_{PRS,i},T_{DRX},TWP), where T_{DRX} may be a length of the UE's DRX cycle and T_{PRS,i} may be the periodicity of the positioning signal resource with muting on PFL i.

In some aspects, if more than one positioning signal periodicities are configured in PFL i, the LCM of positioning signal periodicities among all positioning signal resource sets in the PFL i may be used by the UE to derive T_{PRS,i}. For example, the positioning signal periodicities may be referred to as

$${T}_{per}^{PRS with muting} ,$$

where

$${T}_{per}^{PRS with muting} = {N}_{muting} * {T}_{per}^{PRS} ,$$

may be the positioning signal periodicity with muting per positioning signal resource.

$${T}_{per}^{PRS}$$

may be the periodicity of a set of positioning signal resources (e.g., provided by a higher-layer parameter DL-PRS-Periodicity). N_{muting} may be a scaling factor considering positioning signal resource muting. For example, in one aspect,

$${N}_{muting} = {T}_{muting}^{PRS} * {L}_{muting} ,$$

where

$${T}_{muting}^{PRS}$$

may be a muting repetition factor (e.g., provided by a higher-layer parameter DL-PRS-MutingBitRepetitionFactor), and L_{muting} may be a size of the bitmap (e.g., bitmap {b¹}). In some aspects, for the purpose of calculating T_{PRS,i}, the UE may consider positioning signal resources that are fully or partially covered by the measurement gap, and may not consider positioning signal resources that are not fully or partially covered by the measurement gap. In some aspects, for the purpose of calculating T_{PRS,i}, the UE may consider positioning signal resources that are fully or partially covered by the TW defined by a TW configuration, and may not consider positioning signal resources that are not fully or partially covered by the TW defined by a TW configuration. In some aspects, for the purpose of calculating T_{PRS,i}, the UE may consider positioning signal resources that are fully or partially covered by the measurement gap and by the TW defined by a TW configuration, and may not consider positioning signal resources that are not fully or partially covered by the measurement gap and by the TW.

N may be a duration of positioning signal symbols in ms (e.g., defined in a UE capability variable durationOfPRS-ProcessingSymbols). The UE may process the positioning signals every T ms (e.g., defined in a UE capability variable durationOfPRS-ProcessingSymbolsInEveryTms). The UE capability may be defined per band. In other words, the duration of positioning signal symbols may be for a defined maximum bandwidth supported by the UE (e.g., defined in a UE capability variable supportedBandwidthPRS).

N′ may be a number of positioning signal resources that a UE may process in a slot (e.g., defined in a UE capability variable maxNumOfDL-PRS-ResProcessedPerSlot).

While the measurement period T_{meas_i} may calculate each measurement period for an individual PFL i, in some aspects, the PFL may not be defined by a TW configuration, or the set of resources may have no more than one PFL, such that the calculated variables are not calculated based on a PFL i.

Since one or more of the measurement period variables used to calculate the measurement period T_{meas_i} (e.g., L_{available_PRS,i}, Nₛₐₘₚₗₑ, T_{effect,i}) may be calculated based on the TW configuration, when the TW configuration changes, the UE may change the calculated measurement period T_{meas_i}. In some aspects, a network entity may update a TW configuration while the UE is measuring a set of positioning signals (i.e., the TW configuration is reconfigured). For example, during the measurement period of one or more PFLs, the network entity may transmit an update to a TW configuration, increasing the length of the measurement period used to measure the set of positioning signals.

In some aspects, a network entity may configure a UE to measure a carrier phase of a set of positioning signal measurements. For example, the UE may receive a request to measure a DL-RSCP or a DL-RSCPD. In some aspects, the request may indicate for the UE to report the carrier phase measurement with other measurement types. For example, the request may indicate for the UE to report a DL-RSCP together with a UE Rx-Tx time difference measurement. In another example, a request may indicate for the UE to report a DL-RSCPD together with an RSTD measurement. The UE may calculate a measurement period for both measurements, or a measurement period for each type of measurement. In some aspects, the UE may measure a single resource instance for any carrier phase measurements (e.g., RSCP or RSCPD) and may measure a plurality of resource instances for other types of measurements (e.g., Rx-Tx time difference or RSTD).

In some aspects, a UE that receives a TW configuration and a request for a carrier phase measurement (e.g., a PRS-RSCP measurement or a PRS-RSCPD measurement) may calculate a value for L_{available_PRS,i} based on resources of the positioning signal that are unmuted and fully or partially overlapped with both the measurement gap and the TW indicated in the TW configuration. In some aspects, the TW configuration may indicate specific resources, resource sets, and/or layers to be measured. In such aspects, the UE may calculate the value for L_{available_PRS,i} based on the specified resources, resource sets, and/or layers. If a TW configuration includes an indication that the TW is associated with a set of CPP measurements, and the CPP measurements may be reported separately from non-CPP measurements (e.g., TDOA, RSTD, RSRP), the calculated value for L_{available_PRS,i} based on the TW configuration may apply to the measurement period for the CPP measurements, and a calculated value for L_{available_PRS,i} not based on the TW configuration (e.g., resources that are unmuted and are fully/partially overlapped with the measurement gap but not the TW may be considered) may be used for the non-CPP measurements. If a TW configuration includes an indication that the TW is associated with a set of CPP measurements, and the CPP measurements may be reported together with the non-CPP measurements, the measurement period for the CPP measurements may be the same as the measurement period for the non-CPP measurements.

In some aspects, a UE that receives a TW configuration that indicates a TWP may calculate a value for T_{available_PRS,i} based the TWP. Specifically, the UE may calculate T_{available_PRS,i}=LCM(T_{PRS,i},MGRPᵢ,TWP) during an RRC active mode and T_{available_PRS,i}=LCM(T_{PRS,i},T_{DRX},TWP) during an RRC inactive mode. For the purpose of calculating T_{PRS,i}, the UE may consider the positioning signal resources that are fully or partially covered by the TW, and may not consider the positioning signal resources that are not fully or partially covered by the TW. Updating the value for T_{available_PRS,i} may influence the calculated value for T_{effect,i}, since

$${T}_{effect , i} = ⌈ \frac{{T}_{i}}{{T}_{available \_ PRS , i}} ⌉ * {T}_{available \_ PRS , i} .$$

If a TW configuration includes an indication that the TW is associated with a set of CPP measurements, and the CPP measurements may be reported separately from non-CPP measurements (e.g., TDOA, RSTD, RSRP), the calculated value for T_{available_PRS,i} based on the TWP may apply to the measurement period for the CPP measurements, and a calculated value for T_{available_PRS,i} not based on the TWP (e.g., T_{available_PRS,i}=LCM(T_{PRS,i},MGRPᵢ)) may be used for the non-CPP measurements. If a TW configuration includes an indication that the TW is associated with a set of CPP measurements, and the CPP measurements may be reported together with the non-CPP measurements, the measurement period for the CPP measurements may be the same as the measurement period for the non-CPP measurements.

In some aspects, a UE that receives a request for a carrier phase measurement (e.g., a PRS-RSCP measurement or a PRS-RSCPD measurement) may calculate a value for Nₛₐₘₚₗₑ to equal one with respect to the carrier phase measurement. In other words, the UE may assume the accuracy conditions for the carrier phase measurement to be under the assumption of a single instance to be measured, even if more instances may be used for other types of measurements. Setting Nₛₐₘₚₗₑ=1 for the carrier phase measurement may increase the accuracy of the measurement, as carrier phase measurements across multiple instances may be less accurate than carrier phase measurements across a single instance. The UE may measure other types of measurements (e.g., TDOA, RSTD, RSRP, RSRPP, Rx-Tx, AoA, LOS indication, NLOS indication, or quality indication) using other values for Nₛₐₘₚₗₑ, and may perform both the carrier phase measurements and the other types of measurements during the same measurement period.

In one aspect, if a carrier phase measurement (e.g., PRS-RSCP, or PRS-RSCPD) is requested by a network entity, and if a TW configuration is provided by higher layers, then for calculation of L_{available_PRS,i}, the positioning signal resources fully or partially overlapping with the TW may be considered, and the positioning signal resources that are not fully or partially overlapping with the TW may not be considered. If specific positioning signal resources/sets/layers are indicated to be measured, then those may be considered, and others that were not indicated to be measured may not be considered. In some aspects, for calculating T_{available_PRS,i}=LCM(T_{PRS,i},MGRPᵢ,TWP), the positioning resources that are fully or partially overlapping with the TW may be considered, and the positioning resources that are not fully or partially overlapping with the TW may not be considered. In some aspects, when PRS-RSCP or PRS-RSCPD is configured for DL-TDOA, RSTD and/or RSRP, and both are performed over the same measurement period, the accuracy requirements may be under the assumption that a minimum of a single (Nₛₐₘₚₗₑ=1 instance has been measured for the PRS-RSCP or PRS-RSCPD, even if more instances were used for the other measurements (e.g., DL-TDOA, RSTD and/or RSRP).

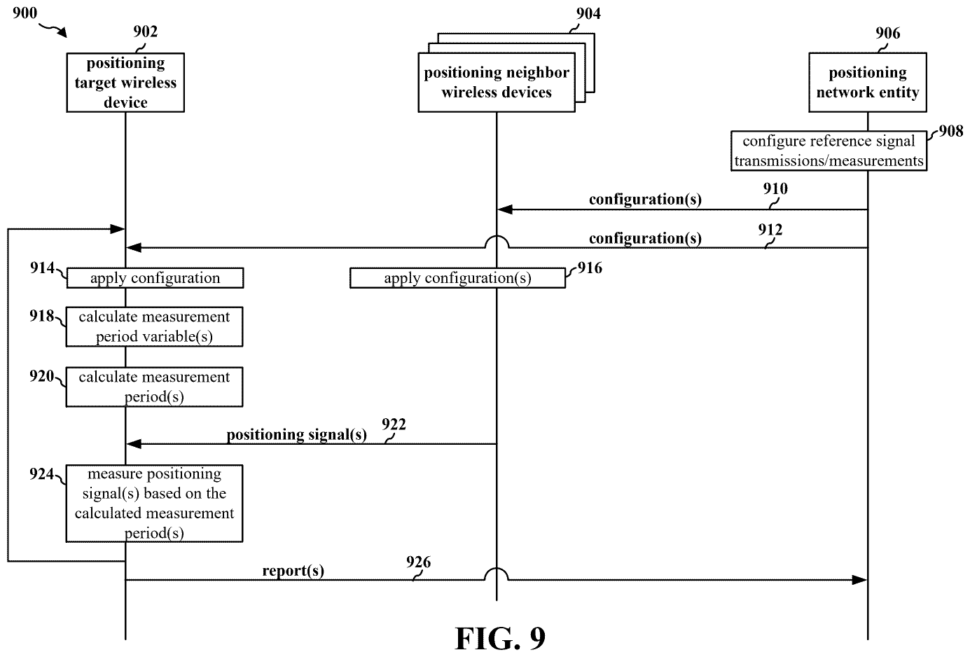

FIG. 9 is a connection flow diagram 900 illustrating an example of a positioning target wireless device 902 configured to measure a set of positioning signals 922 transmitted by the set of positioning neighbor wireless devices 904 based on a TW configuration received from the positioning network entity 906. The positioning target wireless device 902 may include a UE or a PRU. The set of positioning neighbor wireless devices 904 may include one or more base stations or TRPs. The positioning network entity 906 may include a set of location servers or an LMF. The positioning network entity 906 may configure the set of positioning neighbor wireless devices 904 to transmit the set of positioning signals 922 to a plurality of UEs for measurement, one of which may include the positioning target wireless device 902.

At 908, the positioning network entity 906 may configure reference signal transmissions/measurements for the positioning target wireless device 902 and the set of positioning neighbor wireless devices 904. The positioning network entity 906 may transmit a set of configurations 910 at the set of positioning neighbor wireless devices 904. The set of positioning neighbor wireless devices 904 may receive the set of configurations 910 from the positioning network entity 906. At 916, the set of positioning neighbor wireless devices 904 may apply the configuration, for example a schedule for a set of PRSs to be periodically transmitted at the positioning target wireless device 902 during a time period. In some aspects, one of the positioning neighbor wireless devices 904 may include a network node that serves the positioning target wireless device 902. The network node that serves the positioning target wireless device 902 may transmit a configuration of the positioning occasion to the positioning target wireless device 902.

The positioning network entity 906 may transmit a set of configurations 912 at the set of positioning target wireless device 902. The positioning target wireless device 902 may receive the set of configurations 912 from the positioning network entity 906. The set of configurations 912 may include a set of TW configurations associated with a set of measurements of the set of positioning signals 922.

At 914, the positioning target wireless device 902 may apply the set of configurations 912 received from the positioning network entity 906. At 918, the positioning target wireless device 902 may calculate a set of measurement period variables based on the TW configuration. For example, the positioning target wireless device 902 may calculate an L_{available_PRS,i}, which may be a time domain of available positioning signals in a PFL I to be measured. For the calculation of L_{available_PRS,i}, the positioning signal resources that are unmuted and are fully or partially overlapped with the set of TWs may be considered.

At 920, the positioning target wireless device 902 may calculate a set of measurement periods based on the calculated set of measurement period variables. For example, the positioning target wireless device 902 may calculate

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i}$$

based on a calculated L_{available_PRS,i}, and/or a calculated T_{effect,i}.

The set of positioning neighbor wireless devices 904 may transmit the set of positioning signals 922 to the positioning target wireless device 902. The positioning target wireless device 902 may receive the set of positioning signals 922 from the set of positioning neighbor wireless devices 904. At 924, the positioning target wireless device 902 may measure the set of positioning signals 922 based on the calculated set of measurement periods.

While the positioning target wireless device 902 measures the set of positioning signals 922, the positioning network entity 906 may update the TW configuration. In other words, during the measurement period of one or more PFLs of the set of positioning signals 922, the positioning network entity 906 may reconfigure the TW. The positioning network entity 906 may transmit the updated configuration as the set of configurations 912 to the positioning target wireless device 902. The positioning target wireless device 902 may receive the set of configurations 912 from the positioning network entity 906. At 914, the positioning target wireless device 902 may apply the updated configuration. At 918, the positioning target wireless device 902 may recalculate a set of measurement variables based on the updated configuration. At 920 the positioning target wireless device 902 may recalculate the measurement period based on the updated set of measurement variables. This may lengthen the time of the measurement period duration. At 924, the positioning target wireless device 902 may continue to measure the set of positioning signals 922 based on the calculated set of measurement periods.

The positioning target wireless device 902 may transmit a set of reports 926 to the positioning network entity 906. The set of reports 926 may include the measurements taken at 924. In some aspects, the positioning target wireless device 902 may report CPP measurements separately from non-CPP measurements (e.g., TDOA, RSTD, RSRP). If the CPP measurements may be reported separately from the non-CPP measurements, then the positioning target wireless device 902 may report the CPP measurements before reporting the non-CPP measurements in a separate report. In some aspects, the positioning target wireless device 902 may measure the CPP measurements using a single resource instance of the set of positioning signals 922, enabling the positioning target wireless device 902 to perform the calculation of the CPP measurements earlier than the non-CPP measurements. Moreover, the measurement period for the CPP measurements may be based on an L_{available_PRS,i} and T_{available_PRS,i} that are calculated based on the TW configuration, whereas one or more measurement periods for the non-CPP measurements may be based on an L_{available_PRS,i} and T_{available_PRS,i} that are that are not calculated based on the TW configuration.

In other aspects, the positioning target wireless device 902 may report CPP measurements together with non-CPP measurements. In such aspects, the calculated measurement period of all of the reported measurements may be the same. The set of reports 926 may include one report of all of the set of measurements taken of the set of positioning signals 922 taken during the common measurement period.

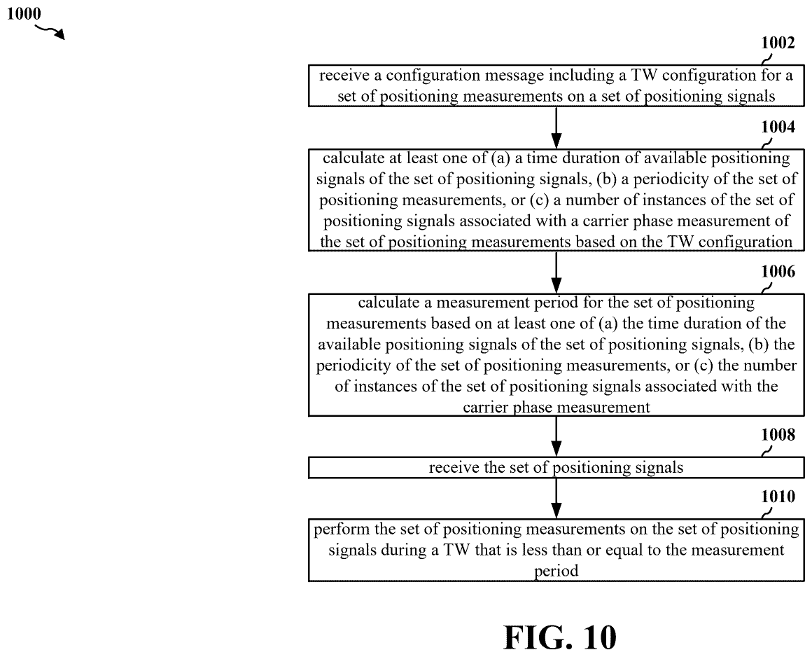

FIG. 10 is a flowchart 1000 of a method of wireless communication. The method may be performed by a UE (e.g., the UE 104, the UE 350; the wireless device 404, the wireless device 504, the wireless device 510; the positioning target wireless device 902; the apparatus 1704). At 1002, the UE may receive a configuration message including a TW configuration for a set of positioning measurements on a set of positioning signals. For example, 1002 may be performed by the positioning target wireless device 902 in FIG. 9, which may receive a set of configurations 912 from the positioning network entity 906. The set of configurations 912 may include a configuration message that includes a TW configuration, such as the TW configuration 710 in FIG. 7) for a set of positioning measurements on the set of positioning signals 922. Moreover, 1002 may be performed by the component 198 in FIG. 1, 3, or 17.

At 1004, the UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. For example, 1004 may be performed by the positioning target wireless device 902 in FIG. 9, which may, at 918, calculate a set of measurement period variables. The measurement period variables may include the of the variables formula

$${T}_{meas \_ i} = ( {k}_{multiTEG , i} * {CSSF}_{P RS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} , \\ such as {L}_{available \_ PRS , i} , {L}_{available \_ PRS , i} , \\ and {T}_{effect , i} .$$

The positioning target wireless device 902 may calculate a time duration of available positioning signals of the set of positioning signals as the variable L_{available_PRS,i} by determining the number of symbols associated with the resources specified in the TW configuration in PFL i that are partially or fully overlapped with the set of TWs defined by the TW configuration. The positioning target wireless device 902 may calculate a periodicity of the set of positioning measurements as the variable T_{available_PRS,i} by calculating LCM(T_{PRS,i},MGRPᵢ,TWP) during an RRC active mode or LCM(T_{PRS,i},T_{DRX},TWP) during an RRC inactive mode. TWP may define a period or a periodicity of the TW as provided by the TW configuration. The positioning target wireless device 902 may calculate a number of instances of the set of positioning signals associated with a carrier phase measurement of the set of positioning measurements as Nₛₐₘₚₗₑ=1 for any carrier phase measurement, such as a PRS-RSCP or a PRS-RSCPD. In some aspects, the positioning target wireless device 902 may also use Nₛₐₘₚₗₑ=2, 3, or 4 to perform a carrier phase measurement, but the positioning target wireless device 902 may measure at least one carrier phase measurement using Nₛₐₘₚₗₑ=1. Moreover, 1004 may be performed by the component 198 in FIG. 1, 3, or 17.

At 1006, the UE may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. For example, 1006 may be performed by the positioning target wireless device 902 in FIG. 9, which may calculate a measurement period, such as T_{meas_i} or T_{meas_Total}, for the set of positioning measurements based on at least one of (a) the calculated time duration of the available positioning signals of the set of positioning signals, (b) the calculated periodicity of the set of positioning measurements, or (c) the calculated number of instances of the set of positioning signals associated with the carrier phase measurement. Moreover, 1006 may be performed by the component 198 in FIG. 1, 3, or 17.

At 1008, the UE may receive the set of positioning signals. For example, 1008 may be performed by the positioning target wireless device 902 in FIG. 9, which may receive the set of positioning signals 922 from the set of positioning neighbor wireless devices 904. Moreover, 1008 may be performed by the component 198 in FIG. 1, 3, or 17.

At 1010, the UE may perform the set of positioning measurements on the set of positioning signals during a TW that is less than or equal to the measurement period. For example, 1010 may be performed by the positioning target wireless device 902 in FIG. 9, which may, at 924, perform the set of positioning measurements on the set of positioning signals 922 during a TW that is less than or equal to the calculated measurement period. Moreover, 1010 may be performed by the component 198 in FIG. 1, 3, or 17.

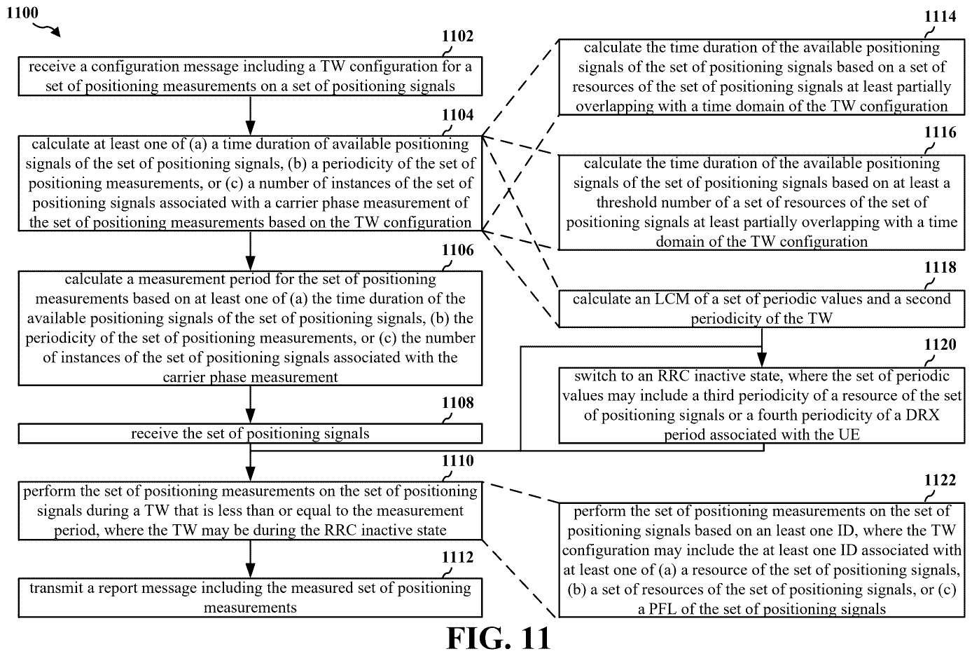

FIG. 11 is a flowchart 1100 of a method of wireless communication. The method may be performed by a UE (e.g., the UE 104, the UE 350; the wireless device 404, the wireless device 504, the wireless device 510; the positioning target wireless device 902; the apparatus 1704). At 1102, the UE may receive a configuration message including a TW configuration for a set of positioning measurements on a set of positioning signals. For example, 1102 may be performed by the positioning target wireless device 902 in FIG. 9, which may receive a set of configurations 912 from the positioning network entity 906. The set of configurations 912 may include a configuration message that includes a TW configuration, such as the TW configuration 710 in FIG. 7) for a set of positioning measurements on the set of positioning signals 922. Moreover, 1102 may be performed by the component 198 in FIG. 1, 3, or 17.

At 1104, the UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. For example, 1104 may be performed by the positioning target wireless device 902 in FIG. 9, which may, at 918, calculate a set of measurement period variables. The measurement period variables may include the of the formula variables

$${T}_{meas \_ i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} , \\ such as {L}_{available \_ PRS , i} , {L}_{available \_ PRS , i} , \\ and {T}_{effect , i} .$$

The positioning target wireless device 902 may calculate a time duration of available positioning signals of the set of positioning signals as the variable L_{available_PRS,i} by determining the number of symbols associated with the resources specified in the TW configuration in PFL i that are partially or fully overlapped with the set of TWs defined by the TW configuration. The positioning target wireless device 902 may calculate a periodicity of the set of positioning measurements as the variable T_{available_PRS,i} by calculating LCM(T_{PRS,i},MGRPᵢ,TWP) during an RRC active mode or LCM(T_{PRS,i},T_{DRX},TWP) during an RRC inactive mode. TWP may define a period or a periodicity of the TW as provided by the TW configuration. The positioning target wireless device 902 may calculate a number of instances of the set of positioning signals associated with a carrier phase measurement of the set of positioning measurements as Nₛₐₘₚₗₑ=1 for any carrier phase measurement, such as a PRS-RSCP or a PRS-RSCPD. In some aspects, the positioning target wireless device 902 may also use Nₛₐₘₚₗₑ=2, 3, or 4 to perform a carrier phase measurement, but the positioning target wireless device 902 may measure at least one carrier phase measurement using Nₛₐₘₚₗₑ=1. Moreover, 1104 may be performed by the component 198 in FIG. 1, 3, or 17.

At 1106, the UE may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. For example, 1106 may be performed by the positioning target wireless device 902 in FIG. 9, which may calculate a measurement period, such as T_{meas_i} or T_{meas_Total}, for the set of positioning measurements based on at least one of (a) the calculated time duration of the available positioning signals of the set of positioning signals, (b) the calculated periodicity of the set of positioning measurements, or (c) the calculated number of instances of the set of positioning signals associated with the carrier phase measurement. Moreover, 1106 may be performed by the component 198 in FIG. 1, 3, or 17.

At 1108, the UE may receive the set of positioning signals. For example, 1108 may be performed by the positioning target wireless device 902 in FIG. 9, which may receive the set of positioning signals 922 from the set of positioning neighbor wireless devices 904. Moreover, 1108 may be performed by the component 198 in FIG. 1, 3, or 17.

At 1110, the UE may perform the set of positioning measurements on the set of positioning signals during a TW that is less than or equal to the measurement period. For example, 1110 may be performed by the positioning target wireless device 902 in FIG. 9, which may, at 924, perform the set of positioning measurements on the set of positioning signals 922 during a TW that is less than or equal to the calculated measurement period. Moreover, 1110 may be performed by the component 198 in FIG. 1, 3, or 17.

At 1112, the UE may transmit a report message including the measured set of positioning measurements. For example, 1112 may be performed by the positioning target wireless device 902 in FIG. 9, which may transmit a set of reports 926 to the positioning network entity 906. The set of reports 926 may include a report message including the measured set of positioning measurements that were measured at 924. Moreover, 1112 may be performed by the component 198 in FIG. 1, 3, or 17. At 1114, the UE may calculate the time duration of available positioning signals of the set of positioning signals by calculating the time duration of the available positioning signals of the set of positioning signals based on a set of resources of the set of positioning signals at least partially overlapping with a time domain of the TW configuration. For example, 1114 may be performed by the positioning target wireless device 902 in FIG. 9, which may, at 918, calculate the time duration of available positioning signals of the set of positioning signals by calculating the time duration of the available positioning signals of the set of positioning signals (e.g., L_{available_PRS,i}) based on a set of resources of the set of positioning signals 922 that are at least partially overlapping with a time domain of the TW configuration of the set of configurations 912. Moreover, 1114 may be performed by the component 198 in FIG. 1, 3, or 17.

At 1116, the UE may calculate the time duration of available positioning signals of the set of positioning signals by calculating the time duration of the available positioning signals of the set of positioning signals based on at least a threshold number of a set of resources of the set of positioning signals at least partially overlapping with a time domain of the TW configuration. For example, 1116 may be performed by the positioning target wireless device 902 in FIG. 9, which may, at 918, calculate the time duration of available positioning signals of the set of positioning signals by calculating the time duration of the available positioning signals of the set of positioning signals (e.g., L_{available_PRS,i}) based on at least a threshold number (e.g., at least 2 or at least 4) of a set of resources of the set of positioning signals 922 at least partially overlapping with a time domain of the TW configuration of the set of configurations 912. The threshold number may be defined by a standard associated with the positioning target wireless device 902 or in the TW configuration. Moreover, 1116 may be performed by the component 198 in FIG. 1, 3, or 17.

At 1118, the UE may calculate the periodicity of the set of positioning measurements by calculating an LCM of a set of periodic values and a second periodicity of the TW. For example, 1118 may be performed by the positioning target wireless device 902 in FIG. 9, which may, at 918, calculate the periodicity of the set of positioning measurements by calculating an LCM of a set of periodic values and a second periodicity of the TW (e.g., LCM(T_{PRS,i},MGRPᵢ,TWP) or LCM(T_{PRS,i},T_{DRX},TWP)). Moreover, 1118 may be performed by the component 198 in FIG. 1, 3, or 17.

At 1120, the UE may switch to an RRC inactive state. The set of periodic values may include a third periodicity of a resource of the set of positioning signals or a fourth periodicity of a discontinuous reception (DRX) period associated with the UE. For example, 1120 may be performed by the positioning target wireless device 902 in FIG. 9, which may switch to an RRC inactive state. The set of periodic values may include a third periodicity of a resource of the set of positioning signals (e.g., T_{PRS,i}) or a fourth periodicity of a DRX period associated with the UE (e.g. T_{DRX}). Moreover, 1120 may be performed by the component 198 in FIG. 1, 3, or 17.

At 1122, the UE may perform the set of positioning measurements on the set of positioning signals based on an least one ID, where the TW configuration may include the at least one ID associated with at least one of (a) a resource of the set of positioning signals, (b) a set of resources of the set of positioning signals, or (c) a PFL of the set of positioning signals. For example, 1122 may be performed by the positioning target wireless device 902 in FIG. 9, which may perform the set of positioning measurements on the set of positioning signals based on an least one ID, where the TW configuration may include the at least one ID associated with at least one of (a) a resource of the set of positioning signals (e.g., one or more resource IDs), (b) a set of resources of the set of positioning signals (e.g., one or more resource set IDs), or (c) a PFL of the set of positioning signals (e.g., one or more PFL IDs). Moreover, 1122 may be performed by the component 198 in FIG. 1, 3, or 17.

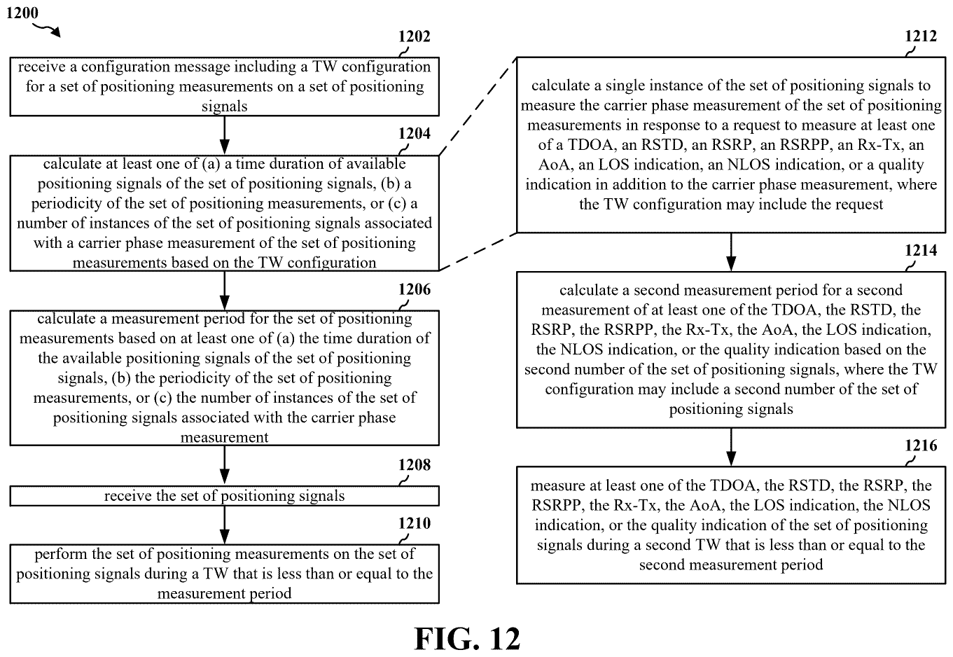

FIG. 12 is a flowchart 1200 of a method of wireless communication. The method may be performed by a UE (e.g., the UE 104, the UE 350; the wireless device 404, the wireless device 504, the wireless device 510; the positioning target wireless device 902; the apparatus 1704). At 1202, the UE may receive a configuration message including a TW configuration for a set of positioning measurements on a set of positioning signals. For example, 1202 may be performed by the positioning target wireless device 902 in FIG. 9, which may receive a set of configurations 912 from the positioning network entity 906. The set of configurations 912 may include a configuration message that includes a TW configuration, such as the TW configuration 710 in FIG. 7) for a set of positioning measurements on the set of positioning signals 922. Moreover, 1202 may be performed by the component 198 in FIG. 1, 3, or 17.

At 1204, the UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. For example, 1204 may be performed by the positioning target wireless device 902 in FIG. 9, which may, at 918, calculate a set of measurement period variables. The measurement period variables may include the variables of the formula

$${T}_{meas \_ i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} , \\ such as {L}_{available \_ PRS , i} , {L}_{available \_ PRS , i} , \\ and {T}_{effect , i} .$$

The positioning target wireless device 902 may calculate a time duration of available positioning signals of the set of positioning signals as the variable L_{available_PRS,i} by determining the number of symbols associated with the resources specified in the TW configuration in PFL i that are partially or fully overlapped with the set of TWs defined by the TW configuration. The positioning target wireless device 902 may calculate a periodicity of the set of positioning measurements as the variable T_{available_PRS,i} by calculating LCM(T_{PRS,i},MGRPᵢ,TWP) during an RRC active mode or LCM(T_{PRS,i},T_{DRX},TWP) during an RRC inactive mode. TWP may define a period or a periodicity of the TW as provided by the TW configuration. The positioning target wireless device 902 may calculate a number of instances of the set of positioning signals associated with a carrier phase measurement of the set of positioning measurements as Nₛₐₘₚₗₑ=1 for any carrier phase measurement, such as a PRS-RSCP or a PRS-RSCPD. In some aspects, the positioning target wireless device 902 may also use Nₛₐₘₚₗₑ=2, 3, or 4 to perform a carrier phase measurement, but the positioning target wireless device 902 may measure at least one carrier phase measurement using Nₛₐₘₚₗₑ=1. Moreover, 1204 may be performed by the component 198 in FIG. 1, 3, or 17.

At 1206, the UE may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. For example, 1206 may be performed by the positioning target wireless device 902 in FIG. 9, which may calculate a measurement period, such as T_{meas_i} or T_{meas_Total}, for the set of positioning measurements based on at least one of (a) the calculated time duration of the available positioning signals of the set of positioning signals, (b) the calculated periodicity of the set of positioning measurements, or (c) the calculated number of instances of the set of positioning signals associated with the carrier phase measurement. Moreover, 1206 may be performed by the component 198 in FIG. 1, 3, or 17.

At 1208, the UE may receive the set of positioning signals. For example, 1208 may be performed by the positioning target wireless device 902 in FIG. 9, which may receive the set of positioning signals 922 from the set of positioning neighbor wireless devices 904. Moreover, 1208 may be performed by the component 198 in FIG. 1, 3, or 17.

At 1210, the UE may perform the set of positioning measurements on the set of positioning signals during a TW that is less than or equal to the measurement period. For example, 1210 may be performed by the positioning target wireless device 902 in FIG. 9, which may, at 924, perform the set of positioning measurements on the set of positioning signals 922 during a TW that is less than or equal to the calculated measurement period. Moreover, 1210 may be performed by the component 198 in FIG. 1, 3, or 17.

At 1212, the UE may calculate the number of instances of the set of positioning signals associated with a carrier phase measurement of the set of positioning measurements based on the TW configuration by calculating a single instance of the set of positioning signals to measure the carrier phase measurement of the set of positioning measurements in response to a request to measure at least one of a TDOA, an RSTD, an RSRP, an RSRPP, an Rx-Tx, an AoA, an LOS indication, an NLOS indication, or a quality indication in addition to the carrier phase measurement, where the TW configuration may include the request. For example, 1212 may be performed by the positioning target wireless device 902 in FIG. 9, which may calculate the number of instances of the set of positioning signals associated with a carrier phase measurement of the set of positioning measurements based on the TW configuration by calculating a single instance (e.g., Nₛₐₘₚₗₑ=1) of the set of positioning signals 922 to measure the carrier phase measurement (e.g., PRS-RSCP or PRS-RSCPD) of the set of positioning measurements in response to a request to measure at least one of a TDOA, an RSTD, an RSRP, an RSRPP, an Rx-Tx, an AoA, an LOS indication, an NLOS indication, or a quality indication in addition to the carrier phase measurement. The TW configuration may include the request, for example the TW configuration may be included in a LocationRequest message that identifies the set of requested measurements. Moreover, 1212 may be performed by the component 198 in FIG. 1, 3, or 17.

At 1214, the UE may calculate a second measurement period for a second measurement of at least one of the TDOA, the RSTD, the RSRP, the RSRPP, the Rx-Tx, the AoA, the LOS indication, the NLOS indication, or the quality indication based on the second number of the set of positioning signals, where the TW configuration may include a second number of the set of positioning signals. For example, 1214 may be performed by the positioning target wireless device 902 in FIG. 9, which may calculate a second measurement period for a second measurement of at least one of the TDOA, the RSTD, the RSRP, the RSRPP, the Rx-Tx, the AoA, the LOS indication, the NLOS indication, or the quality indication based on the second number of the set of positioning signals (e.g., A T_{meas_i} or a T_{meas_Total} not based on the TW configuration). The TW configuration may include a second number of the set of positioning signals (e.g., an Nₛₐₘₚₗₑ value specific to one or more non-carrier phase measurements). Moreover, 1214 may be performed by the component 198 in FIG. 1, 3, or 17.

At 1216, the UE may measure at least one of the TDOA, the RSTD, the RSRP, the RSRPP, the Rx-Tx, the AoA, the LOS indication, the NLOS indication, or the quality indication of the set of positioning signals during a second TW that is less than or equal to the second measurement period. For example, 1216 may be performed by the positioning target wireless device 902 in FIG. 9, which may, at 924, measure at least one of the TDOA, the RSTD, the RSRP, the RSRPP, the Rx-Tx, the AoA, the LOS indication, the NLOS indication, or the quality indication of the set of positioning signals 922 during a second TW that is less than or equal to the calculated second measurement period. Moreover, 1216 may be performed by the component 198 in FIG. 1, 3, or 17.

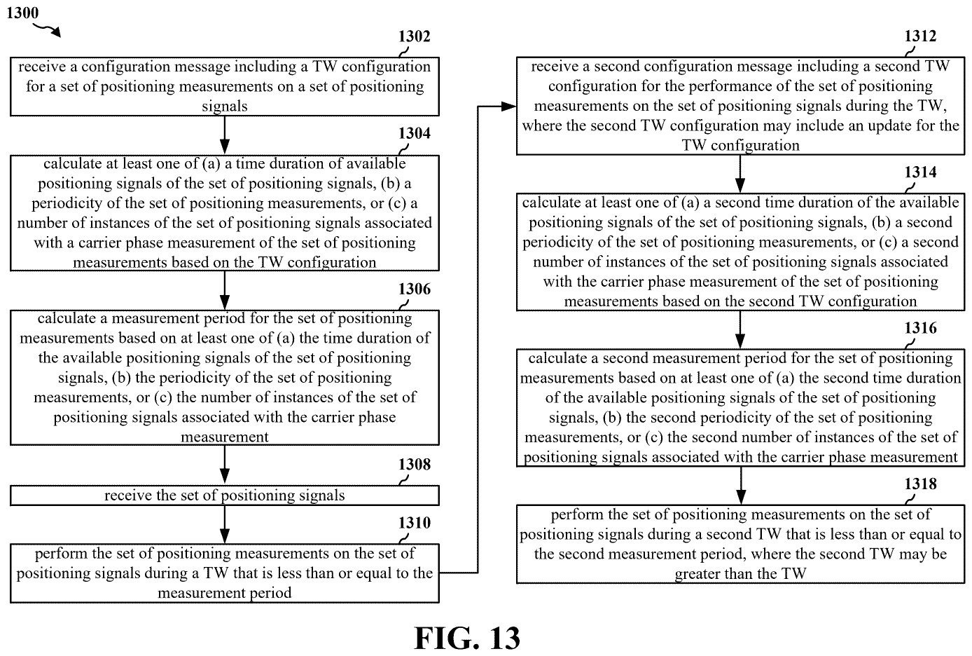

FIG. 13 is a flowchart 1300 of a method of wireless communication. The method may be performed by a UE (e.g., the UE 104, the UE 350; the wireless device 404, the wireless device 504, the wireless device 510; the positioning target wireless device 902; the apparatus 1704). At 1302, the UE may receive a configuration message including a TW configuration for a set of positioning measurements on a set of positioning signals. For example, 1302 may be performed by the positioning target wireless device 902 in FIG. 9, which may receive a set of configurations 912 from the positioning network entity 906. The set of configurations 912 may include a configuration message that includes a TW configuration, such as the TW configuration 710 in FIG. 7) for a set of positioning measurements on the set of positioning signals 922. Moreover, 1302 may be performed by the component 198 in FIG. 1, 3, or 17.

At 1304, the UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. For example, 1304 may be performed by the positioning target wireless device 902 in FIG. 9, which may, at 918, calculate a set of measurement period variables. The measurement period variables may include the variables of the formula

$${T}_{meas \_ i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{a v ailable \_ PRS , i}}{N} ⌉ * {N}_{sample} - 1 ) * {T}_{effect , i} + {T}_{last , i} , \\ such as {L}_{available \_ PRS , i} , {L}_{available \_ PRS , i} , \\ and {T}_{effect , t} .$$

The positioning target wireless device 902 may calculate a time duration of available positioning signals of the set of positioning signals as the variable L_{available_PRS,i} by determining the number of symbols associated with the resources specified in the TW configuration in PFL i that are partially or fully overlapped with the set of TWs defined by the TW configuration. The positioning target wireless device 902 may calculate a periodicity of the set of positioning measurements as the variable T_{available_PRS,i} by calculating LCM(T_{PRS,i},MGRPᵢ,TWP) during an RRC active mode or LCM(T_{PRS,i},T_{DRX},TWP) during an RRC inactive mode. TWP may define a period or a periodicity of the TW as provided by the TW configuration. The positioning target wireless device 902 may calculate a number of instances of the set of positioning signals associated with a carrier phase measurement of the set of positioning measurements as Nₛₐₘₚₗₑ=1 for any carrier phase measurement, such as a PRS-RSCP or a PRS-RSCPD. In some aspects, the positioning target wireless device 902 may also use Nₛₐₘₚₗₑ=2, 3, or 4 to perform a carrier phase measurement, but the positioning target wireless device 902 may measure at least one carrier phase measurement using Nₛₐₘₚₗₑ=1. Moreover, 1304 may be performed by the component 198 in FIG. 1, 3, or 17.

At 1306, the UE may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. For example, 1306 may be performed by the positioning target wireless device 902 in FIG. 9, which may calculate a measurement period, such as T_{meas_i} or T_{meas_Total}, for the set of positioning measurements based on at least one of (a) the calculated time duration of the available positioning signals of the set of positioning signals, (b) the calculated periodicity of the set of positioning measurements, or (c) the calculated number of instances of the set of positioning signals associated with the carrier phase measurement. Moreover, 1306 may be performed by the component 198 in FIG. 1, 3, or 17.

At 1308, the UE may receive the set of positioning signals. For example, 1308 may be performed by the positioning target wireless device 902 in FIG. 9, which may receive the set of positioning signals 922 from the set of positioning neighbor wireless devices 904. Moreover, 1308 may be performed by the component 198 in FIG. 1, 3, or 17.

At 1310, the UE may perform the set of positioning measurements on the set of positioning signals during a TW that is less than or equal to the measurement period. For example, 1310 may be performed by the positioning target wireless device 902 in FIG. 9, which may, at 924, perform the set of positioning measurements on the set of positioning signals 922 during a TW that is less than or equal to the calculated measurement period. Moreover, 1310 may be performed by the component 198 in FIG. 1, 3, or 17.

At 1312, the UE may receive a second configuration message including a second TW configuration for the performance of the set of positioning measurements on the set of positioning signals during the TW, where the second TW configuration may include an update for the TW configuration. For example, 1312 may be performed by the positioning target wireless device 902 in FIG. 9, which may receive a second configuration message as the updated TW configuration in the set of configurations 912, including a second TW configuration (e.g., for a reconfigured TW) for the performance of the set of positioning measurements on the set of positioning signals 922 during the TW. The second TW configuration may include an update, or a reconfiguration, of the original TW configuration. Moreover, 1312 may be performed by the component 198 in FIG. 1, 3, or 17.

At 1314, the UE may calculate at least one of (a) a second time duration of the available positioning signals of the set of positioning signals, (b) a second periodicity of the set of positioning measurements, or (c) a second number of instances of the set of positioning signals associated with the carrier phase measurement of the set of positioning measurements based on the second TW configuration. For example, 1314 may be performed by the positioning target wireless device 902 in FIG. 9, which may calculate at least one of (a) a second time duration of the available positioning signals of the set of positioning signals, (b) a second periodicity of the set of positioning measurements, or (c) a second number of instances of the set of positioning signals associated with the carrier phase measurement of the set of positioning measurements based on the updated TW configuration. Moreover, 1314 may be performed by the component 198 in FIG. 1, 3, or 17.

At 1316, the UE may calculate a second measurement period for the set of positioning measurements based on at least one of (a) the second time duration of the available positioning signals of the set of positioning signals, (b) the second periodicity of the set of positioning measurements, or (c) the second number of instances of the set of positioning signals associated with the carrier phase measurement. For example, 1316 may be performed by the positioning target wireless device 902 in FIG. 9, which may calculate an updated measurement period for the set of positioning measurements based on at least one of (a) the second time duration of the available positioning signals of the set of positioning signals, (b) the second periodicity of the set of positioning measurements, or (c) the second number of instances of the set of positioning signals associated with the carrier phase measurement. Moreover, 1316 may be performed by the component 198 in FIG. 1, 3, or 17.

At 1318, the UE may perform the set of positioning measurements on the set of positioning signals during a second TW that is less than or equal to the second measurement period, where the second TW may be greater than the TW. For example, 1318 may be performed by the positioning target wireless device 902 in FIG. 9, which may, at 924, perform the set of positioning measurements on the set of positioning signals 922 during a second TW that is less than or equal to the calculated second measurement period. The second TW may be greater than the original TW based on the original TW configuration. In other words, the duration of the measurement window may be longer as a result of the reconfiguration of the TW. Moreover, 1318 may be performed by the component 198 in FIG. 1, 3, or 17.

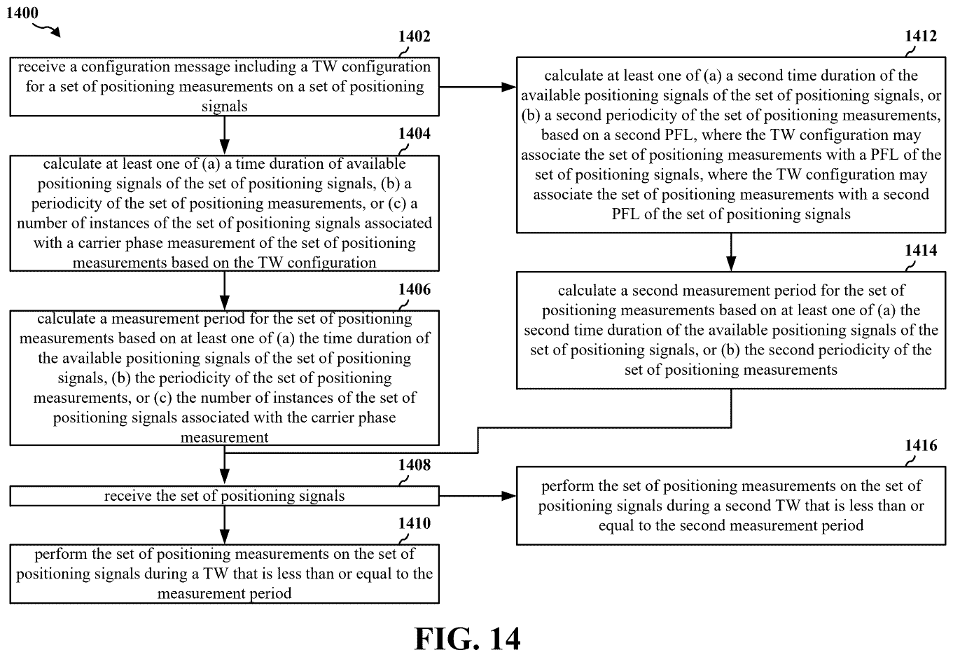

FIG. 14 is a flowchart 1400 of a method of wireless communication. The method may be performed by a UE (e.g., the UE 104, the UE 350; the wireless device 404, the wireless device 504, the wireless device 510; the positioning target wireless device 902; the apparatus 1704). At 1402, the UE may receive a configuration message including a TW configuration for a set of positioning measurements on a set of positioning signals. For example, 1402 may be performed by the positioning target wireless device 902 in FIG. 9, which may receive a set of configurations 912 from the positioning network entity 906. The set of configurations 912 may include a configuration message that includes a TW configuration, such as the TW configuration 710 in FIG. 7) for a set of positioning measurements on the set of positioning signals 922. Moreover, 1402 may be performed by the component 198 in FIG. 1, 3, or 17.

At 1404, the UE may calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. For example, 1404 may be performed by the positioning target wireless device 902 in FIG. 9, which may, at 918, calculate a set of measurement period variables. The measurement period variables may include the variables of the formula

$${T}_{meas \_ i} = ( {k}_{multiTEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} , \\ such as {L}_{available \_ PRS , i} , {L}_{available \_ PRS , i} , \\ and {T}_{effect , i} .$$

The positioning target wireless device 902 may calculate a time duration of available positioning signals of the set of positioning signals as the variable L_{available_PRS,i} by determining the number of symbols associated with the resources specified in the TW configuration in PFL i that are partially or fully overlapped with the set of TWs defined by the TW configuration. The positioning target wireless device 902 may calculate a periodicity of the set of positioning measurements as the variable T_{available_PRS,i} by calculating LCM(T_{PRS,i},MGRPᵢ,TWP) during an RRC active mode or LCM(T_{PRS,i},T_{DRX},TWP) during an RRC inactive mode. TWP may define a period or a periodicity of the TW as provided by the TW configuration. The positioning target wireless device 902 may calculate a number of instances of the set of positioning signals associated with a carrier phase measurement of the set of positioning measurements as Nₛₐₘₚₗₑ=1 for any carrier phase measurement, such as a PRS-RSCP or a PRS-RSCPD. In some aspects, the positioning target wireless device 902 may also use Nₛₐₘₚₗₑ=2, 3, or 4 to perform a carrier phase measurement, but the positioning target wireless device 902 may measure at least one carrier phase measurement using Nₛₐₘₚₗₑ=1. Moreover, 1404 may be performed by the component 198 in FIG. 1, 3, or 17.

At 1406, the UE may calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. For example, 1406 may be performed by the positioning target wireless device 902 in FIG. 9, which may calculate a measurement period, such as T_{meas_i} or T_{meas_Total}, for the set of positioning measurements based on at least one of (a) the calculated time duration of the available positioning signals of the set of positioning signals, (b) the calculated periodicity of the set of positioning measurements, or (c) the calculated number of instances of the set of positioning signals associated with the carrier phase measurement. Moreover, 1406 may be performed by the component 198 in FIG. 1, 3, or 17.

At 1408, the UE may receive the set of positioning signals. For example, 1408 may be performed by the positioning target wireless device 902 in FIG. 9, which may receive the set of positioning signals 922 from the set of positioning neighbor wireless devices 904. Moreover, 1408 may be performed by the component 198 in FIG. 1, 3, or 17.

At 1410, the UE may perform the set of positioning measurements on the set of positioning signals during a TW that is less than or equal to the measurement period. For example, 1410 may be performed by the positioning target wireless device 902 in FIG. 9, which may, at 924, perform the set of positioning measurements on the set of positioning signals 922 during a TW that is less than or equal to the calculated measurement period. Moreover, 1410 may be performed by the component 198 in FIG. 1, 3, or 17.

At 1412, the UE may calculate at least one of (a) a second time duration of the available positioning signals of the set of positioning signals, or (b) a second periodicity of the set of positioning measurements, based on a second PFL, where the TW configuration may associate the set of positioning measurements with a PFL of the set of positioning signals, where the TW configuration may associate the set of positioning measurements with a second PFL of the set of positioning signals. For example, 1412 may be performed by the positioning target wireless device 902 in FIG. 9, which may, at 918, calculate at least one of (a) a second time duration of the available positioning signals of the set of positioning signals, or (b) a second periodicity of the set of positioning measurements, based on a second PFL (e.g., a PFL₂). The TW configuration may associate the set of positioning measurements with a PFL (e.g., PFL₁) of the set of positioning signals. The TW configuration may associate the set of positioning measurements with a second PFL (e.g., PFL₁) of the set of positioning signals. Moreover, 1412 may be performed by the component 198 in FIG. 1, 3, or 17.

At 1414, the UE may calculate a second measurement period for the set of positioning measurements based on at least one of (a) the second time duration of the available positioning signals of the set of positioning signals, or (b) the second periodicity of the set of positioning measurements. For example, 1414 may be performed by the positioning target wireless device 902 in FIG. 9, which may, at 920, calculate a second measurement period (e.g., T_{meas_2}, whereas the measurement period may be T_{meas_1}) for the set of positioning measurements based on at least one of (a) the second time duration of the available positioning signals of the set of positioning signals, or (b) the second periodicity of the set of positioning measurements. Moreover, 1414 may be performed by the component 198 in FIG. 1, 3, or 17.

At 1416, the UE may perform the set of positioning measurements on the set of positioning signals during a second TW that is less than or equal to the second measurement period. For example, 1416 may be performed by the positioning target wireless device 902 in FIG. 9, which may, at 924, perform the set of positioning measurements on the set of positioning signals during a second TW that is less than or equal to the second measurement period. Moreover, 1416 may be performed by the component 198 in FIG. 1, 3, or 17.

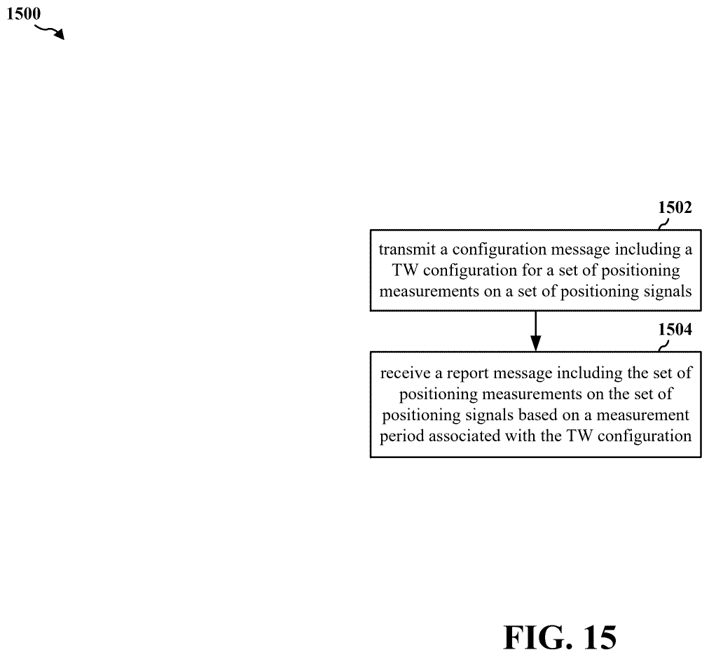

FIG. 15 is a flowchart 1500 of a method of wireless communication. The method may be performed by a network entity, (e.g., the base station 102, the base station 310; the wireless device 402, the wireless device 406, the wireless device 502, the wireless device 506; one of the positioning neighbor wireless devices 904; the positioning network entity 906; the network entity 1702, the network entity 1502, the network entity 1960). At 1502, the network entity may transmit a configuration message including a TW configuration for a set of positioning measurements on a set of positioning signals. For example, 1502 may be performed by the positioning network entity 906 in FIG. 9, which may transmit a set of configurations 912 to the positioning target wireless device 902. The set of configurations 912 may include a configuration message including a TW configuration for a set of positioning measurements on the set of positioning signals 922. Moreover, 1502 may be performed by the component 199 in FIG. 1, 3, 18, or 19.

At 1504, the network entity may receive a report message including the set of positioning measurements on the set of positioning signals based on a measurement period associated with the TW configuration. For example, 1504 may be performed by the positioning network entity 906 in FIG. 9, which may receive a set of reports 926. The set of reports 926 may include a report message including the set of positioning measurements on the set of positioning signals 922 based on a measurement period associated with the TW configuration. Moreover, 1504 may be performed by the component 199 in FIG. 1, 3, 18, or 19.

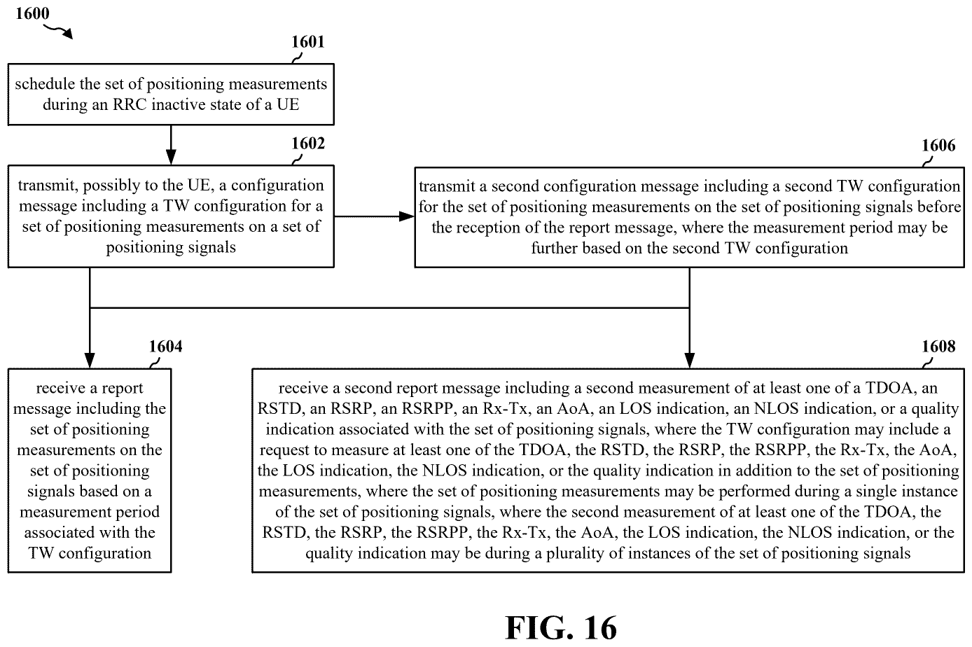

FIG. 16 is a flowchart 1600 of a method of wireless communication. The method may be performed by a network entity, (e.g., the base station 102, the base station 310; the wireless device 402, the wireless device 406, the wireless device 502, the wireless device 506; one of the positioning neighbor wireless devices 904; the positioning network entity 906; the network entity 1702, the network entity 1502, the network entity 1960). At 1601, the network entity may schedule the set of positioning measurements during an RRC inactive state of a UE. For example, 1601 may be performed by the positioning network entity 906 in FIG. 9, which may, at 908, schedule the set of positioning measurements during an RRC inactive state of the positioning target wireless device 902. Moreover, 1601 may be performed by the component 199 in FIG. 1, 3, 18, or 19.

At 1602, the network entity may transmit a configuration message including a TW configuration for a set of positioning measurements on a set of positioning signals. For example, 1602 may be performed by the positioning network entity 906 in FIG. 9, which may transmit a set of configurations 912 to the positioning target wireless device 902. The set of configurations 912 may include a configuration message including a TW configuration for a set of positioning measurements on the set of positioning signals 922. Moreover, 1602 may be performed by the component 199 in FIG. 1, 3, 18, or 19.

At 1604, the network entity may receive a report message including the set of positioning measurements on the set of positioning signals based on a measurement period associated with the TW configuration. For example, 1604 may be performed by the positioning network entity 906 in FIG. 9, which may receive a set of reports 926. The set of reports 926 may include a report message including the set of positioning measurements on the set of positioning signals 922 based on a measurement period associated with the TW configuration. Moreover, 1604 may be performed by the component 199 in FIG. 1, 3, 18, or 19.

At 1606, the network entity may transmit a second configuration message including a second TW configuration for the set of positioning measurements on the set of positioning signals before the reception of the report message, where the measurement period may be further based on the second TW configuration. For example, 1606 may be performed by the positioning network entity 906 in FIG. 9, which may transmit a second configuration message as the set of configurations 912 including a second TW configuration for the set of positioning measurements on the set of positioning signals 922 before the reception of the set of reports 926. The measurement period may be further based on the second TW configuration. In other words, the measurement period may be longer as a result of the reconfiguration of the TW configuration. Moreover, 1606 may be performed by the component 199 in FIG. 1, 3, 18, or 19.

At 1608, the network entity may receive a second report message including a second measurement of at least one of a TDOA, an RSTD, an RSRP, an RSRPP, an Rx-Tx, an AoA, an LOS indication, an NLOS indication, or a quality indication associated with the set of positioning signals, where the TW configuration may include a request to measure at least one of the TDOA, the RSTD, the RSRP, the RSRPP, the Rx-Tx, the AoA, the LOS indication, the NLOS indication, or the quality indication in addition to the carrier phase measurement, where the set of positioning measurements may be performed during a single instance of the set of positioning signals, where the second measurement of at least one of the TDOA, the RSTD, the RSRP, the RSRPP, the Rx-Tx, the AoA, the LOS indication, the NLOS indication, or the quality indication may be during a plurality of instances of the set of positioning signals. For example, 1608 may be performed by the positioning network entity 906 in FIG. 9, which may receive a set of reports 926. The set of reports 926 may include a first report having a carrier phase measurement (e.g., PRS-RSCP or PRS RSCPD). The set of reports 926 may include a second report message including the measurement of at least one of a TDOA, an RSTD, an RSRP, an RSRPP, an Rx-Tx, an AoA, an LOS indication, an NLOS indication, or a quality indication associated with the set of positioning signals. The TW configuration in the set of configurations 912 may include a request to measure at least one of the TDOA, the RSTD, the RSRP, the RSRPP, the Rx-Tx, the AoA, the LOS indication, the NLOS indication, or the quality indication in addition to the carrier phase measurement. The set of positioning measurements including the carrier phase measurement may be performed at 924 during a single instance of the set of positioning signals 922. The measurement of at least one of the TDOA, the RSTD, the RSRP, the RSRPP, the Rx-Tx, the AoA, the LOS indication, the NLOS indication, or the quality indication may be during a plurality of instances of the set of positioning signals 922. Moreover, 1608 may be performed by the component 199 in FIG. 1, 3, 18, or 19.

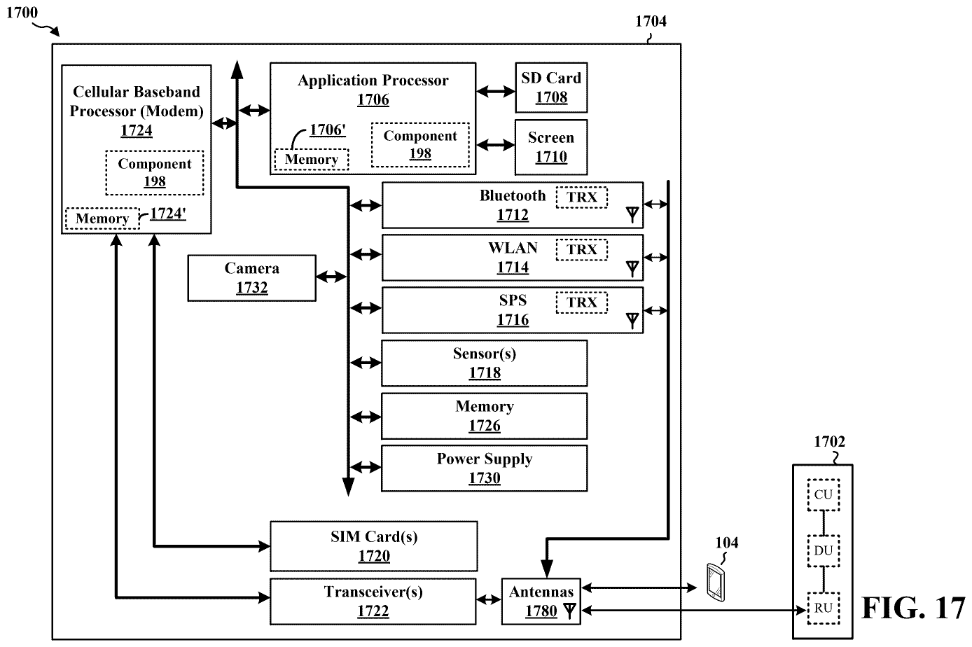

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to receive a configuration message including a TW configuration for a set of positioning measurements on a set of positioning signals. The component 198 may be configured to calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The component 198 may be configured to calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The component 198 may be configured to receive the set of positioning signals. The component 198 may be configured to perform the set of positioning measurements on the set of positioning signals during a TW that is less than or equal to the measurement period. The component 198 may be configured to transmit a report message including the measured set of positioning measurements. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for receiving a configuration message including a TW configuration for a set of positioning measurements on a set of positioning signals. The apparatus 1704 may include means for calculating at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The apparatus 1704 may include means for calculating a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The apparatus 1704 may include means for receiving the set of positioning signals. The apparatus 1704 may include means for performing the set of positioning measurements on the set of positioning signals during a TW that is less than or equal to the measurement period. The apparatus 1704 may include means for transmitting a report message including the measured set of positioning measurements. The apparatus 1704 may include means for calculating the time duration of the available positioning signals of the set of positioning signals based on the TW configuration by calculating the time duration of the available positioning signals of the set of positioning signals based on a set of resources of the set of positioning signals at least partially overlapping with a time domain of the TW configuration. The TW configuration may include an ID associated with at least one of (a) a resource of the set of positioning signals, (b) a set of resources of the set of positioning signals, or (c) a positioning frequency layer (PFL) of the set of positioning signals. The apparatus 1704 may include means for performing the set of positioning measurements on the set of positioning signals by performing the set of positioning measurements on the set of positioning signals based on the ID. The apparatus 1704 may include means for calculating the time duration of the available positioning signals of the set of positioning signals based on the TW configuration by calculating the time duration of the available positioning signals of the set of positioning signals based on at least a threshold number of a set of resources of the set of positioning signals at least partially overlapping with a time domain of the TW configuration. The set of resources may include unmuted repetitions of a resource instance of the set of positioning signals. The apparatus 1704 may include means for calculating the periodicity of the set of positioning measurements based on the TW configuration by calculating an LCM of a set of periodic values and a second periodicity of the TW. The set of periodic values may include at least one of a third periodicity of a resource of the set of positioning signals or a fourth periodicity of an MG associated with the set of positioning signals. The set of periodic values may include a third periodicity of a resource of the set of positioning signals or a fourth periodicity of a DRX period associated with the apparatus 1704. The apparatus 1704 may include means for switching to an RRC inactive state before the performance of the set of positioning measurements on the set of positioning signals during the TW. The TW may be during the RRC inactive state. The TW configuration may include a request to measure at least one of a TDOA, an RSTD, an RSRP, an RSRPP, an Rx-Tx, an AoA, an LOS indication, an NLOS indication, or a quality indication in addition to the carrier phase measurement. The apparatus 1704 may include means for calculating the number of instances of the set of positioning signals based on the TW configuration by calculating a single instance of the set of positioning signals to measure the carrier phase measurement of the set of positioning measurements in response to the request. The TW configuration may include a second number of the set of positioning signals. The apparatus 1704 may include means for calculating a second measurement period for a second measurement of at least one of the TDOA, the RSTD, the RSRP, the RSRPP, the Rx-Tx, the AoA, the LOS indication, the NLOS indication, or the quality indication based on the second number of the set of positioning signals. The apparatus 1704 may include means for measuring at least one of the TDOA, the RSTD, the RSRP, the RSRPP, the Rx-Tx, the AoA, the LOS indication, the NLOS indication, or the quality indication of the set of positioning signals during a second TW that is less than or equal to the second measurement period. The apparatus 1704 may include means for receiving a second configuration message including a second TW configuration for the performance of the set of positioning measurements on the set of positioning signals during the TW. The second TW configuration may include an update for the TW configuration. The apparatus 1704 may include means for calculating at least one of (a) a second time duration of the available positioning signals of the set of positioning signals, (b) a second periodicity of the set of positioning measurements, or (c) a second number of instances of the set of positioning signals associated with the carrier phase measurement of the set of positioning measurements based on the second TW configuration. The apparatus 1704 may include means for calculating a second measurement period for the set of positioning measurements based on at least one of (a) the second time duration of the available positioning signals of the set of positioning signals, (b) the second periodicity of the set of positioning measurements, or (c) the second number of instances of the set of positioning signals associated with the carrier phase measurement. The apparatus 1704 may include means for performing the set of positioning measurements on the set of positioning signals during a second TW that is less than or equal to the second measurement period. The second TW may be greater than the TW. The TW configuration may associate the set of positioning measurements with a set of measurement types. At least one measurement type in the set of measurement types may include a carrier phase measurement type. The TW configuration may associate the set of positioning measurements with a PFL of the set of positioning signals. The TW configuration may associate the set of positioning measurements with a second PFL of the set of positioning signals. The apparatus 1704 may include means for calculating at least one of (a) a second time duration of the available positioning signals of the set of positioning signals, or (b) a second periodicity of the set of positioning measurements, based on the second PFL. The apparatus 1704 may include means for calculating a second measurement period for the set of positioning measurements based on at least one of (a) the second time duration of the available positioning signals of the set of positioning signals, or (b) the second periodicity of the set of positioning measurements. The apparatus 1704 may include means for performing the set of positioning measurements on the set of positioning signals during a second TW that is less than or equal to the second measurement period. The TW configuration may associate at least one of the set of positioning measurements with a measurement type of the set of positioning signals. The measurement type may include at least one of (a) a CPP measurement, (b) a TDOA measurement, (c) an RSTD measurement, (d) an RSRP measurement, (e) an RSRPP measurement, (f) an Rx-Tx measurement, (g) an AoA measurement, (h) an LOS indication measurement, (i) an NLOS indication measurement, or (j) a quality indication measurement. The apparatus 1704 may include a UE. The apparatus 1704 may include a PRU. The set of positioning measurements may include at least one of an RSCP measurement or an RSCPD measurement. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

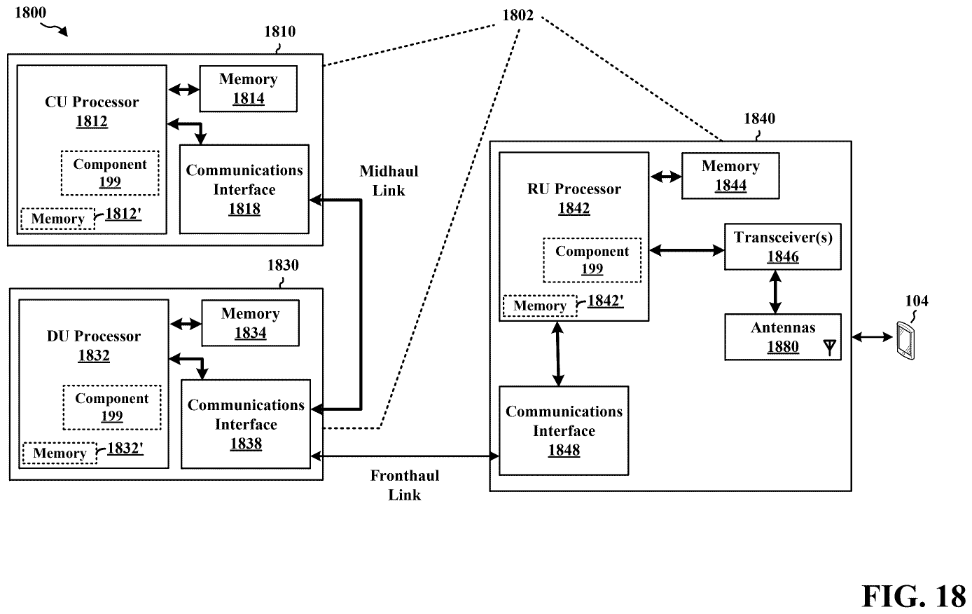

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a configuration message including a TW configuration for a set of positioning measurements on a set of positioning signals. The component 199 may be configured to receive a report message including the set of positioning measurements on the set of positioning signals based on a measurement period associated with the TW configuration. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for transmitting a configuration message including a TW configuration for a set of positioning measurements on a set of positioning signals. The network entity 1802 may include means for receiving a report message comprising the set of positioning measurements on the set of positioning signals based on a measurement period associated with the TW configuration. The TW configuration may include an indication of a TWP. The measurement period may be further based on the TWP. The network entity 1802 may include means for scheduling the set of positioning measurements during an RRC inactive state of a UE. The network entity 1802 may include means for transmitting the configuration message by transmitting the configuration message to the UE. The TW configuration may include a request to measure at least one of a TDOA, an RSTD, an RSRP, an RSRPP, an Rx-Tx, an AoA, an LOS indication, an NLOS indication, or a quality indication in addition to the carrier phase measurement. The network entity 1802 may include means for receiving a second report message including a second measurement of at least one of the TDOA, the RSTD, the RSRP, the RSRPP, the Rx-Tx, the AoA, the LOS indication, the NLOS indication, or the quality indication associated with the set of positioning signals. The set of positioning measurements may be performed during a single instance of the set of positioning signals. The second measurement of at least one of the TDOA, the RSTD, the RSRP, the RSRPP, the Rx-Tx, the AoA, the LOS indication, the NLOS indication, or the quality indication may be during a plurality of instances of the set of positioning signals. The network entity 1802 may include means for transmitting a second configuration message including a second TW configuration for the set of positioning measurements on the set of positioning signals before the reception of the report message. The measurement period may be further based on the second TW configuration. The TW configuration may be associated with a carrier phase measurement with the set of positioning measurements and may lack association with at least one measurement of the set of positioning measurements. The TW configuration may associate a PFL of the set of positioning signals with the set of positioning measurements. The TW configuration may associate a second PFL of the set of positioning signals with the set of positioning measurements. The measurement period may be further based on the second PFL. The TW configuration may associate a set of measurement types with the set of positioning measurements. The set of measurement types may include at least one of (a) a CPP measurement, (b) a TDOA measurement, (c) an RSTD measurement, (d) an RSRP measurement, (e) an RSRPP measurement, (f) an Rx-Tx measurement, (g) an AoA measurement, (h) an LOS indication measurement, (i) an NLOS indication measurement, or (j) a quality indication measurement. The network entity 1802 may include an LMF. The set of positioning measurements may include at least one of an RSCP measurement or an RSCPD measurement. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

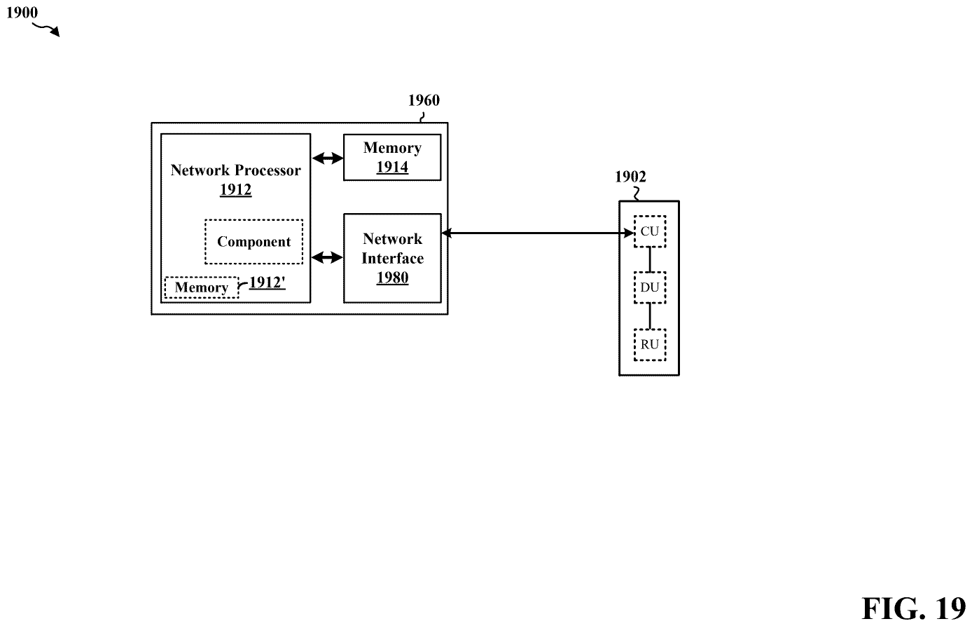

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a configuration message including a TW configuration for a set of positioning measurements on a set of positioning signals. The component 199 may be configured to receive a report message including the set of positioning measurements on the set of positioning signals based on a measurement period associated with the TW configuration. The component 199 may be within the processor 1912. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 may include means for transmitting a configuration message including a TW configuration for a set of positioning measurements on a set of positioning signals. The network entity 1960 may include means for receiving a report message comprising the set of positioning measurements on the set of positioning signals based on a measurement period associated with the TW configuration. The TW configuration may include an indication of a TWP. The measurement period may be further based on the TWP. The network entity 1960 may include means for scheduling the set of positioning measurements during an RRC inactive state of a UE. The network entity 1960 may include means for transmitting the configuration message by transmitting the configuration message to the UE. The TW configuration may include a request to measure at least one of a TDOA, an RSTD, an RSRP, an RSRPP, an Rx-Tx, an AoA, an LOS indication, an NLOS indication, or a quality indication in addition to the carrier phase measurement. The network entity 1960 may include means for receiving a second report message including a second measurement of at least one of the TDOA, the RSTD, the RSRP, the RSRPP, the Rx-Tx, the AoA, the LOS indication, the NLOS indication, or the quality indication associated with the set of positioning signals. The set of positioning measurements may be performed during a single instance of the set of positioning signals. The second measurement of at least one of the TDOA, the RSTD, the RSRP, the RSRPP, the Rx-Tx, the AoA, the LOS indication, the NLOS indication, or the quality indication may be during a plurality of instances of the set of positioning signals. The network entity 1960 may include means for transmitting a second configuration message including a second TW configuration for the set of positioning measurements on the set of positioning signals before the reception of the report message. The measurement period may be further based on the second TW configuration. The TW configuration may be associated with a carrier phase measurement with the set of positioning measurements and may lack association with at least one measurement of the set of positioning measurements. The TW configuration may associate a PFL of the set of positioning signals with the set of positioning measurements. The TW configuration may associate a second PFL of the set of positioning signals with the set of positioning measurements. The measurement period may be further based on the second PFL. The TW configuration may associate a set of measurement types with the set of positioning measurements. The set of measurement types may include at least one of (a) a CPP measurement, (b) a TDOA measurement, (c) an RSTD measurement, (d) an RSRP measurement, (e) an RSRPP measurement, (f) an Rx-Tx measurement, (g) an AoA measurement, (h) an LOS indication measurement, (i) an NLOS indication measurement, or (j) a quality indication measurement. The network entity 1960 may include an LMF. The set of positioning measurements may include at least one of an RSCP measurement or an RSCPD measurement. The means may be the component 199 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may output the data to another component of the device. A device configured to “obtain” data, such as a transmission, signal, or message, may receive the data, for example with a transceiver, may obtain the data from a device that receives the data, or may input the data from another component of the device. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), where the method comprises receiving a configuration message comprising a timing window (TW) configuration for a set of positioning measurements on a set of positioning signals. The method further comprises calculating at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration. The method further comprises calculating a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement. The method further comprises receiving the set of positioning signals. The method further comprises performing the set of positioning measurements on the set of positioning signals during a TW that is less than or equal to the measurement period.

Aspect 2 is the method of aspect 1, where calculating the time duration of the available positioning signals of the set of positioning signals based on the TW configuration comprises calculating the time duration of the available positioning signals of the set of positioning signals based on a set of resources of the set of positioning signals at least partially overlapping with a time domain of the TW configuration.

Aspect 3 is the method of either of aspects 1 or 2, wherein the TW configuration comprises an identifier (ID) associated with at least one of (a) a resource of the set of positioning signals, (b) a set of resources of the set of positioning signals, or (c) a positioning frequency layer (PFL) of the set of positioning signals. Performing the set of positioning measurements on the set of positioning signals comprises performing the set of positioning measurements on the set of positioning signals based on the ID.

Aspect 4 is the method of any of aspects 1 to 3, wherein calculating the time duration of the available positioning signals of the set of positioning signals based on the TW configuration comprises calculating the time duration of the available positioning signals of the set of positioning signals based on at least a threshold number of a set of resources of the set of positioning signals at least partially overlapping with a time domain of the TW configuration.

Aspect 5 is the method of aspect 4, wherein the set of resources comprises unmuted repetitions of a resource instance of the set of positioning signals.

Aspect 6 is the method of any of aspects 1 to 5, wherein calculating the periodicity of the set of positioning measurements based on the TW configuration comprises calculating a least common multiple (LCM) of a set of periodic values and a second periodicity of the TW.

Aspect 7 is the method of aspect 6, wherein the set of periodic values include at least one of a third periodicity of a resource of the set of positioning signals or a fourth periodicity of a measurement gap (MG) associated with the set of positioning signals.

Aspect 8 is the method of either of aspects 6 or 7, wherein the set of periodic values comprises a third periodicity of a resource of the set of positioning signals or a fourth periodicity of a discontinuous reception (DRX) period associated with the UE.

Aspect 9 is the method of aspect 8, wherein the method further comprises switching to a radio resource control (RRC) inactive state before the performance of the set of positioning measurements on the set of positioning signals during the TW, wherein the TW is during the RRC inactive state.

Aspect 10 is the method of any of aspects 1 to 9, wherein the TW configuration comprises a request to measure at least one of a time difference of arrival (TDOA), a reference signal time difference (RSTD), a reference signal received power (RSRP), a RSRP path (RSRPP), a reception transmission (Rx-Tx), an angle of arrival (AoA), a line of sight (LOS) indication, a non-line of sight (NLOS) indication, or a quality indication in addition to the carrier phase measurement. Calculating the number of instances of the set of positioning signals based on the TW configuration comprises calculating a single instance of the set of positioning signals to measure the carrier phase measurement of the set of positioning measurements in response to the request.

Aspect 11 is the method of aspect 10, wherein the TW configuration comprises a second number of the set of positioning signals. The method further comprises calculating a second measurement period for a second measurement of at least one of the TDOA, the RSTD, the RSRP, the RSRPP, the Rx-Tx, the AoA, the LOS indication, the NLOS indication, or the quality indication based on the second number of the set of positioning signals. The method further comprises measuring at least one of the TDOA, the RSTD, the RSRP, the RSRPP, the Rx-Tx, the AoA, the LOS indication, the NLOS indication, or the quality indication of the set of positioning signals during a second TW that is less than or equal to the second measurement period.

Aspect 12 is the method of any of aspects 1 to 11, wherein the method further comprises receiving a second configuration message comprising a second TW configuration for the performance of the set of positioning measurements on the set of positioning signals during the TW, wherein the second TW configuration comprises an update for the TW configuration. The method further comprises calculating at least one of (a) a second time duration of the available positioning signals of the set of positioning signals, (b) a second periodicity of the set of positioning measurements, or (c) a second number of instances of the set of positioning signals associated with the carrier phase measurement of the set of positioning measurements based on the second TW configuration. The method further comprises calculating a second measurement period for the set of positioning measurements based on at least one of (a) the second time duration of the available positioning signals of the set of positioning signals, (b) the second periodicity of the set of positioning measurements, or (c) the second number of instances of the set of positioning signals associated with the carrier phase measurement. The method further comprises performing the set of positioning measurements on the set of positioning signals during a second TW that is less than or equal to the second measurement period, wherein the second TW is greater than the TW.

Aspect 13 is the method of any of aspects 1 to 12, wherein the TW configuration associates the set of positioning measurements with a set of measurement types, wherein at least one measurement type in the set of measurement types comprises a carrier phase measurement type.

Aspect 14 is the method of any of aspects 1 to 13, wherein the TW configuration associates the set of positioning measurements with a positioning frequency layer (PFL) of the set of positioning signals.

Aspect 15 is the method of any of aspects 1 to 14, wherein the TW configuration associates the set of positioning measurements with a second PFL of the set of positioning signals. The method further comprises calculating at least one of (a) a second time duration of the available positioning signals of the set of positioning signals, or (b) a second periodicity of the set of positioning measurements, based on the second PFL. The method further comprises calculating a second measurement period for the set of positioning measurements based on at least one of (a) the second time duration of the available positioning signals of the set of positioning signals, or (b) the second periodicity of the set of positioning measurements. The method further comprises performing the set of positioning measurements on the set of positioning signals during a second TW that is less than or equal to the second measurement period.

Aspect 16 is the method of any of aspects 1 to 15, wherein the TW configuration associates at least one of the set of positioning measurements with a measurement type of the set of positioning signals.

Aspect 17 is the method of aspect 16, wherein the measurement type comprises at least one of (a) a carrier phase positioning (CPP) measurement, (b) a time difference of arrival (TDOA) measurement, (c) a reference signal time difference (RSTD) measurement, (d) a reference signal received power (RSRP) measurement, (e) a RSRP path (RSRPP) measurement, (f) a reception transmission (Rx-Tx) measurement, (g) an angle of arrival (AoA) measurement, (h) a line of sight (LOS) indication measurement, (i) a non-line of sight (NLOS) indication measurement, or (j) a quality indication measurement.

Aspect 18 is the method of any of aspects 1 to 17, wherein the UE comprises a positioning reference unit (PRU).

Aspect 19 is the method of any of aspects 1 to 18, wherein the set of positioning measurements comprises at least one of a reference signal carrier phase (RSCP) measurement or a reference signal carrier phase difference (RSCPD) measurement.

Aspect 20 is a method of wireless communication at a network entity, wherein the method comprises transmitting a configuration message comprising a timing window (TW) configuration for a set of positioning measurements on a set of positioning signals. The method further comprises receiving a report message comprising the set of positioning measurements on the set of positioning signals based on a measurement period associated with the TW configuration.

Aspect 21 is the method of aspect 20, wherein the TW configuration comprises an indication of a periodicity of a TW (TWP), wherein the measurement period is further based on the TWP.

Aspect 22 is the method of either of aspects 20 or 21, wherein the method further comprises scheduling the set of positioning measurements during a radio resource control (RRC) inactive state of a user equipment (UE), wherein transmitting the configuration message comprises transmitting the configuration message to the UE.

Aspect 23 is the method of any of aspects 20 to 23, wherein the TW configuration comprises a request to measure at least one of a time difference of arrival (TDOA), a reference signal time difference (RSTD), a reference signal received power (RSRP), a RSRP path (RSRPP), a reception transmission (Rx-Tx), an angle of arrival (AoA), a line of sight (LOS) indication, a non-line of sight (NLOS) indication, or a quality indication.

Aspect 24 is the method of any of aspects 20 to 23, wherein the method further comprises receiving a second report message comprising a second measurement of at least one of the TDOA, the RSTD, the RSRP, the RSRPP, the Rx-Tx, the AoA, the LOS indication, the NLOS indication, or the quality indication associated with the set of positioning signals, wherein the set of positioning measurements is performed during a single instance of the set of positioning signals, wherein the second measurement of at least one of the TDOA, the RSTD, the RSRP, the RSRPP, the Rx-Tx, the AoA, the LOS indication, the NLOS indication, or the quality indication is during a plurality of instances of the set of positioning signals.

Aspect 25 is the method of any of aspects 20 to 24, wherein the method further comprises transmitting a second configuration message comprising a second TW configuration for the set of positioning measurements on the set of positioning signals before the reception of the report message, wherein the measurement period is further based on the second TW configuration.

Aspect 26 is the method of any of aspects 20 to 25, wherein the TW configuration is associated with a carrier phase measurement with the set of positioning measurements and lacks association with at least one measurement of the set of positioning measurements.

Aspect 27 is the method of any of aspects 20 to 26, wherein the TW configuration associates a positioning frequency layer (PFL) of the set of positioning signals with the set of positioning measurements.

Aspect 28 is the method of aspect 27, wherein the TW configuration associates a second PFL of the set of positioning signals with the set of positioning measurements, wherein the measurement period is further based on the second PFL.

Aspect 29 is the method of any of aspects 20 to 28, wherein the TW configuration associates a set of measurement types with the set of positioning measurements.

Aspect 30 is the method of any of aspects 20 to 29, wherein the set of measurement types comprise at least one of (a) a carrier phase positioning (CPP) measurement, (b) a time difference of arrival (TDOA) measurement, (c) a reference signal time difference (RSTD) measurement, (d) a reference signal received power (RSRP) measurement, (e) a RSRP path (RSRPP) measurement, (f) a reception transmission (Rx-Tx) measurement, (g) an angle of arrival (AoA) measurement, (h) a line of sight (LOS) indication measurement, (i) a non-line of sight (NLOS) indication measurement, or (j) a quality indication measurement.

Aspect 31 is the method of any of aspects 20 to 30, wherein the network entity comprises a location management function (LMF).

Aspect 32 is the method of any of aspects 20 to 31, wherein the set of positioning measurements comprises at least one of a reference signal carrier phase (RSCP) measurement or a reference signal carrier phase difference (RSCPD) measurement.

Aspect 33 is an apparatus for wireless communication, including: at least one memory; and at least one processor coupled to the at least one memory and, based at least in part on information stored in the at least one memory, the at least one processor, individually, or in any combination, is configured to implement any of aspects 1 to 32.

Aspect 34 is the apparatus of aspect 33, further including at least one of an antenna or a transceiver coupled to the at least one processor.

Aspect 35 is an apparatus for wireless communication including means for implementing any of aspects 1 to 32.

Aspect 36 is a computer-readable medium (e.g., a non-transitory computer-readable medium) storing computer executable code, where the code when executed by a processor causes the processor to implement any of aspects 1 to 32.

1. An apparatus for wireless communication at a user equipment (UE), comprising:
at least one memory; and
at least one processor coupled to the at least one memory and, based at least in part on information stored in the at least one memory, the at least one processor is configured to:
receive a configuration message comprising a timing window (TW) configuration for a set of positioning measurements on a set of positioning signals;
calculate at least one of (a) a time duration of available positioning signals of the set of positioning signals, (b) a periodicity of the set of positioning measurements, or (c) a number of instances of the set of positioning signals associated with a carrier phase measurement of the set of positioning measurements based on the TW configuration;
calculate a measurement period for the set of positioning measurements based on at least one of (a) the time duration of the available positioning signals of the set of positioning signals, (b) the periodicity of the set of positioning measurements, or (c) the number of instances of the set of positioning signals associated with the carrier phase measurement;
receive the set of positioning signals; and
perform the set of positioning measurements on the set of positioning signals during a TW that is less than or equal to the measurement period.

2. The apparatus of claim 1, wherein, to calculate the time duration of the available positioning signals of the set of positioning signals based on the TW configuration, the at least one processor is configured to:
calculate the time duration of the available positioning signals of the set of positioning signals based on a set of resources of the set of positioning signals at least partially overlapping with a time domain of the TW configuration.

3. The apparatus of claim 1, wherein the TW configuration comprises an identifier (ID) associated with at least one of (a) a resource of the set of positioning signals, (b) a set of resources of the set of positioning signals, or (c) a positioning frequency layer (PFL) of the set of positioning signals, wherein, to perform the set of positioning measurements on the set of positioning signals, the at least one processor is configured to:
perform the set of positioning measurements on the set of positioning signals based on the ID.

4. The apparatus of claim 1, wherein, to calculate the time duration of the available positioning signals of the set of positioning signals based on the TW configuration, the at least one processor is configured to:
calculate the time duration of the available positioning signals of the set of positioning signals based on at least a threshold number of a set of resources of the set of positioning signals at least partially overlapping with a time domain of the TW configuration.

5. The apparatus of claim 4, wherein the set of resources comprises unmuted repetitions of a resource instance of the set of positioning signals.

6. The apparatus of claim 1, wherein, to calculate the periodicity of the set of positioning measurements based on the TW configuration, the at least one processor is configured to:
calculate a least common multiple (LCM) of a set of periodic values and a second periodicity of the TW.

7. The apparatus of claim 6, wherein the set of periodic values comprises at least one of a third periodicity of a resource of the set of positioning signals or a fourth periodicity of a measurement gap (MG) associated with the set of positioning signals.

8. The apparatus of claim 6, wherein the set of periodic values comprises a third periodicity of a resource of the set of positioning signals or a fourth periodicity of a discontinuous reception (DRX) period associated with the UE.

9. The apparatus of claim 8, wherein the at least one processor is configured to:
switch to a radio resource control (RRC) inactive state before the performance of the set of positioning measurements on the set of positioning signals during the TW, wherein the TW is during the RRC inactive state.

10. The apparatus of claim 1, wherein the TW configuration comprises a request to measure at least one of a time difference of arrival (TDOA), a reference signal time difference (RSTD), a reference signal received power (RSRP), a RSRP path (RSRPP), a reception transmission (Rx-Tx), an angle of arrival (AoA), a line of sight (LOS) indication, a non-line of sight (NLOS) indication, or a quality indication in addition to the carrier phase measurement, wherein, to calculate the number of instances of the set of positioning signals based on the TW configuration, the at least one processor is configured to:
calculate a single instance of the set of positioning signals to measure the carrier phase measurement of the set of positioning measurements in response to the request.

11. The apparatus of claim 10, wherein the TW configuration comprises a second number of the set of positioning signals, wherein the at least one processor is configured to:
calculate a second measurement period for a second measurement of at least one of the TDOA, the RSTD, the RSRP, the RSRPP, the Rx-Tx, the AoA, the LOS indication, the NLOS indication, or the quality indication based on the second number of the set of positioning signals; and
measure at least one of the TDOA, the RSTD, the RSRP, the RSRPP, the Rx-Tx, the AoA, the LOS indication, the NLOS indication, or the quality indication of the set of positioning signals during a second TW that is less than or equal to the second measurement period.

12. The apparatus of claim 1, further comprising a transceiver coupled to the at least one processor, wherein the at least one processor is configured to:
receive, via the transceiver, a second configuration message comprising a second TW configuration for the performance of the set of positioning measurements on the set of positioning signals during the TW, wherein the second TW configuration comprises an update for the TW configuration;
calculate at least one of (a) a second time duration of the available positioning signals of the set of positioning signals, (b) a second periodicity of the set of positioning measurements, or (c) a second number of instances of the set of positioning signals associated with the carrier phase measurement of the set of positioning measurements based on the second TW configuration;
calculate a second measurement period for the set of positioning measurements based on at least one of (a) the second time duration of the available positioning signals of the set of positioning signals, (b) the second periodicity of the set of positioning measurements, or (c) the second number of instances of the set of positioning signals associated with the carrier phase measurement; and
perform the set of positioning measurements on the set of positioning signals during a second TW that is less than or equal to the second measurement period, wherein the second TW is greater than the TW.

13. The apparatus of claim 1, wherein the TW configuration associates the set of positioning measurements with a set of measurement types, wherein at least one measurement type in the set of measurement types comprises a carrier phase measurement type.

14. The apparatus of claim 1, wherein the TW configuration associates the set of positioning measurements with a positioning frequency layer (PFL) of the set of positioning signals.

15. The apparatus of claim 14, wherein the TW configuration associates the set of positioning measurements with a second PFL of the set of positioning signals, wherein the at least one processor is configured to:
calculate at least one of (a) a second time duration of the available positioning signals of the set of positioning signals, or (b) a second periodicity of the set of positioning measurements, based on the second PFL;
calculate a second measurement period for the set of positioning measurements based on at least one of (a) the second time duration of the available positioning signals of the set of positioning signals, or (b) the second periodicity of the set of positioning measurements; and
perform the set of positioning measurements on the set of positioning signals during a second TW that is less than or equal to the second measurement period.

16. The apparatus of claim 1, wherein the TW configuration associates at least one of the set of positioning measurements with a measurement type of the set of positioning signals.

17. The apparatus of claim 16, wherein the measurement type comprises at least one of:
a carrier phase positioning (CPP) measurement;
a time difference of arrival (TDOA) measurement;
a reference signal time difference (RSTD) measurement;
a reference signal received power (RSRP) measurement;
a RSRP path (RSRPP) measurement;
a reception transmission (Rx-Tx) measurement;
an angle of arrival (AoA) measurement;
a line of sight (LOS) indication measurement;
a non-line of sight (NLOS) indication measurement; or
a quality indication measurement.

18. The apparatus of claim 1, wherein the UE comprises a positioning reference unit (PRU).

19. The apparatus of claim 1, wherein the set of positioning measurements comprises at least one of a reference signal carrier phase (RSCP) measurement or a reference signal carrier phase difference (RSCPD) measurement.

20. An apparatus for wireless communication at a network node, comprising:
at least one memory; and
at least one processor coupled to the at least one memory and, based at least in part on information stored in the at least one memory, the at least one processor is configured to:
transmit a configuration message comprising a timing window (TW) configuration for a set of positioning measurements on a set of positioning signals; and
receive a report message comprising the set of positioning measurements on the set of positioning signals based on a measurement period associated with the TW configuration.

21-30. (canceled)
